(19) United States
(12) Patent Application Publication
(10) Pub. No.: US 2025/0042506 A1
(43) Pub. Date: Feb. 6, 2025

(54) GEARBOX WITH NO BREAK IN TORQUE

(71) Applicant: Franck SAVARD, PLENEUF-VAL-ANDRE (FR)

(72) Inventor: Franck SAVARD, PLENEUF-VAL-ANDRE (FR)

(21) Appl. No.: 18/697,181

(22) PCT Filed: Sep. 30, 2021
(86) PCT No.: PCT/EP2021/076932

§ 371 Date: Mar. 29, 2024

(30) Foreign Application Priority Data
Oct. 2, 2020 (FR) FR2010096

(51) Int. Cl. B62M 11/06; B62M 17/00; B62M 25/00

(52) U.S. Cl. CPC B62M 11/06; B62M 25/00; B62M 17/00

(57) ABSTRACT

A gearbox having a primary shaft, a secondary shaft, gears forming the gear ratios, sliding gears providing the changes in gear ratio, and forks, each fork having a guide finger and a control barrel. The primary and secondary shafts are connected to one another by the gears. Each gear includes a wheel connected fixedly in terms of rotation to a shaft, and an idling pinion mounted on the other shaft. Each idling pinion includes claws. Each sliding gear collaborates with one or two idling pinions and is moved towards the associated one or two idling pinions by a fork. Each sliding gear includes claws that complement the claws of the idling pinion or pinions with which it collaborates. The barrel includes guide members, each guide member guides the guide finger of the fork. The assembly including the forks, sliding gears, idling pinions and guide members forms a gear selection system.

### TECHNICAL FIELD OF THE INVENTION

The invention relates to a gearbox.

In particular, the invention aims to improve the feeling, the performances and the reliability of the gear shifts by avoiding torque breaks, the power supply cuts when incrementing the gears, the risks of false neutral points, breakages of forks and/or of pinions in the gearbox.

The invention finds a particular application in the field of gearboxes for motor vehicles, with a heat engine or an electric motor. Nevertheless, the invention may also be advantageously implemented in two-wheeled vehicles, motor-driven or not, or in machine tools.

### BACKGROUND OF THE INVENTION

Among the different types of existing gearbox, gearboxes so-called with no break in torque are known.

A gearbox with no break in torque for a motor vehicle is generally a dual clutch gearbox. It conventionally comprises a primary shaft, connected to an electric motor or a heat engine, and two coaxial secondary shafts connected to the wheels of the vehicle. The primary shaft and the two secondary shafts are connected together via gears forming the gear ratios. Each gear comprises a gear wheel, fixedly linked in rotation to the primary shaft, and an idler pinion mounted on one of the secondary shafts. The idler pinions defining the even gear ratios are carried by one of the secondary shafts, and those defining the odd gear ratios are carried by the other secondary shaft. The idler pinions are in free rotation relative to their secondary shaft except when a sliding gear secures one of the idler pinions with their secondary shaft to engage the corresponding gear ratio. Each of the sliding gears is linked to a rigid fork, movable in translation. The translational movement of the rigid forks is imparted by a control barrel.

The gearbox further comprises a first clutch for controlling one of the secondary shafts and a second clutch for controlling the other secondary shaft. Such a dual clutch gearbox requires a system for synchronizing said clutches to carry out the gear shifts. For example, when an upper gear should be engaged, the synchronization system automatically declutches the secondary shaft carrying the idler pinion of the gear corresponding to the lower gear.

Such a gearbox is complex.

In the case of a gearbox for a cycle, there is neither a fork nor sliding gears or a clutch as described before. The gearbox comprises a primary shaft, which is also the crankset axis, one single secondary shaft and a tertiary shaft, most often coaxial with the primary shaft. Radial pawls are mounted in the secondary shaft, on a coaxial axis. Each pawl respectively secures an idler pinion with the secondary shaft to engage the corresponding gear ratio. Said pawls are controlled by a mechanism internal to said secondary shaft.

In such a gearbox, the load take-up points in the idler pinion/pawl connection are limited, whether in number (1 to 2 maximum), or in diameter, by the fact of being internal to said shaft. In addition, the number of parts, generally with reduced dimensions, their fragility and the complexity of assembly thereof have a non-negligible impact on the reliability, the cost and the maintenance of the gearbox.

### OBJECT AND SUMMARY OF THE INVENTION

The present invention aims to overcome the aforementioned drawbacks.

In particular, the present invention proposes an alternative to existing gearboxes with no break in torque.

Advantageously, the gearbox could be used for motor vehicles, with a heat engine or an electric motor, such as for example karts, cars, agricultural machines, etc., as well as for two-wheeled motor vehicles, motor-driven or not, such as cycles, motorcycles or electrically-assisted bikes, or for conventional or numerically-controlled machine tools.

To this end, the gearbox according to the invention comprises at least two shafts, so-called the primary shaft and the secondary shaft, gears forming the gear ratios, sliding gears ensuring shifting of the gear ratios, forks and a control barrel.

Said primary shaft and said secondary shaft are connected together by the gears. Each gear comprises a gear wheel, fixedly linked in rotation to one of the two shafts, and an idler pinion, mounted on the other shaft, which mesh with one another. Each idler pinion comprises claws. Each sliding gear is configured to cooperate with one or two idler pinion(s). Each sliding gear is able to move towards the associated one or two idler pinion(s) by means of a fork. Each sliding gear comprises claws complementary to the claws of the one or two idler pinion(s) with which it cooperates.

Each fork comprises a guide finger. Said guide finger of a fork is secured to the latter. Thus, the guide finger acts directly on the fork, it drives it directly. The guide finger and the fork can be made in the form of a one-piece part.

Preferably, a fork comprises a blade. Preferably, the blade comprises a body and two branches connected to said body. The guide finger is secured to the blade of the fork, preferably secured to the body of the fork.

Advantageously, a fork provided with a guide finger allows reducing the number of parts to be assembled in the gearbox, simplifying mounting of the fork in said gearbox and thus making the gearbox more robust.

The control barrel comprises guide members, each guide member being configured to guide the guide finger of a fork.

All of the forks, sliding gears, idler pinions and guide members of the gearbox form a gear selection system. A fork, a sliding gear, the associated one or two idler pinion(s) and a guide member associated with the fork form the elements of a subassembly of said gear selection system.

The gearbox according to the invention is characterized in that one element of each subassembly comprises an elastic return means, this elastic return means being in particular configured, when a new gear ratio is engaged, to uncouple the sliding gear from the idler pinion of the gear forming the previously engaged gear ratio.

Preferably, in the gearbox, one single element of each subassembly comprises an elastic return means.

Advantageously, during a gear shift, such an elastic return means allows timing, on the one hand, clutching of a sliding gear with an idler pinion during the engagement of a gear ratio and, on the other hand, declutching of one sliding gear from an idler pinion during the disengagement of a previous gear ratio.

By “clutching”, it should be understood the cooperation of a sliding gear with an idler pinion, engaging a gear ratio formed by the gear comprising said idler pinion.

By “declutching”, it should be understood the extraction of the sliding gear from an idler pinion, disengaging the gear ratio formed by the gear comprising said idler pinion.

In particular embodiments, the invention further embodies the following features, implemented separately or in each of their technically-feasible combinations.

Preferably, the movement of the guide finger directly drives the fork, i.e. the movement of the blade and therefore of the associated sliding gear, independently of the elastic return means.

Preferably, all of the gear wheels are fixedly linked to the primary shaft and all of the idler pinions are mounted on the secondary shaft.

In this configuration, the kinematic chain is as follows:
the driving force (crankset or motor) acts on the primary shaft driving the gear wheels of the different gear ratios in rotation.
the gear wheels drive by meshing the different idler pinions with which they are associated.
each idler pinion drives the sliding gear with which it is clutched in rotation.
each sliding gear, being fixedly linked in rotation to the secondary shaft, drives the latter to ensure the driving output of the gearbox.

In another configuration, where all of the idler pinions are mounted on the primary shaft, the situation of the driving/driven elements is reversed with regards to the previously-described configuration.

In particular embodiments, the gearbox comprises a third shaft, called tertiary shaft. The gear wheels and idler pinions are distributed over the three shafts. The addition of a tertiary shaft may be advantageous in the case of a cycle, where the primary shaft would be the crankset axis and the tertiary shaft would be the output shaft of the gearbox. The tertiary shaft allows resetting the direction of rotation identical to that of the primary shaft.

In particular embodiments of the invention, when a sliding gear cooperates with one single idler pinion, the gearbox can comprise an odd number of gears, therefore an odd number of gear ratios.

In particular embodiments of the invention when a sliding gear cooperates with two idler pinions, said sliding gear is interposed between two consecutive idler pinions of the same shaft. The sliding gear comprises two opposite lateral faces, and comprises, at the level of each of these lateral faces, claws intended to cooperate with the claws of the opposite idler pinion.

In particular embodiments of the invention, in a subassembly, the fork comprises the elastic return means.

In particular embodiments of the invention, the fork comprises at least one flexible blade. Said at least one flexible blade forms the elastic return means. The at least one blade deforms elastically.

Thus, to engage a gear ratio, one of the sliding gears is moved, by the associated fork, towards the idler pinion of the gear forming the desired gear ratio, to clutch it.

When the claws of said sliding gear arrive at the claws of the idler pinion, if the claws cannot cooperate together because they are not in-phase with one another, thanks to its elasticity, the blade of the fork could bend temporarily and be under stress. As soon as the claws of the sliding gear and those of the idler pinion are in-phase, thanks to its elasticity, the flexible blade of the fork will automatically return to its rest state, exerting a pressing force on the sliding gear to push it towards the idler pinion, making them clutch together and engage the desired gear ratio.

The flexible blade of the fork enables the sliding gear, which should be coupled with an idler pinion, to wait for phasing of the different claws and that being so without effort.

Similarly, in order to disengage a previous gear ratio, the sliding gear which is clutched to the idler pinion of the gear forming said gear ratio is moved, by the fork, to bring it back into a neutral position. Yet, as long as the gear ratio is engaged, the idler pinion is under pressure and it is impossible to declutch the sliding gear from said idler pinion. Thanks to its elasticity, the flexible blade of the fork could bend temporarily and be under stress. As soon as the upper gear ratio is engaged, the idler pinion of the previous gear ratio will be able to rotate less quickly than the shaft carrying said idler pinion and the pressure on the sliding gear will then be released. The claws of said sliding gear and the claws of the idler pinion are then naturally uncoupled. Thanks to its elasticity, the flexible blade of the fork will then automatically return to its rest state, exerting a return force on the sliding gear to bring it back into its neutral position after declutching from the idler pinion. Said idler pinion becomes again free in rotation relative to the shaft that carries it.

Thus, the flexible blade of the fork enables the sliding gear, which should be uncoupled from the idler pinion, to return to its neutral position, to wait for the pressure on said idler pinion to be released, smoothly, without effort and naturally.

In particular embodiments of the invention, in a subassembly, the guide finger of the fork is a so-called oscillating guide finger, held at neutral by springs, the oscillating guide finger and the springs forming the elastic return means. The guide finger is partially accommodated in a core of the fork. The core comprises a through bore intended to receive a guide axis of the fork. In these particular forms, the blade of the fork is a rigid blade. The core comprises an aperture for the passage of said guide finger.

Thus, in order to engage a gear ratio, one of the sliding gears is moved, by the associated fork, towards the idler pinion of the gear forming the desired gear ratio, to clutch it. When the claws of said sliding gear arrive at the claws of the idler pinion, if the claws cannot cooperate together because they are not in-phase with one another, the movement of said sliding gear is blocked, simultaneously blocking the movement of the fork and of its core on the guide axis. The guide finger of the fork continues to follow the movement of the track, while shifting into the aperture of the core, and compressing one of the springs in said core, which is then temporarily under stress. As soon as the claws of the sliding gear and those of the idler pinion are in-phase, thanks to its elasticity, the compressed spring will automatically return to its rest state, causing movement of the core of the fork along the guide axis, and therefore movement of the blade of the fork and of the associated sliding gear. Thus, said sliding gear is pushed towards the idler pinion, making them clutch together and engage the desired gear ratio. The elasticity of the springs enables the sliding gear, which should be coupled with an idler pinion, to wait for phasing of the different claws and that being so without effort.

Similarly, to disengage a previous gear ratio, the sliding gear which is clutched to the idler pinion of the gear forming said gear ratio is moved, by the fork, to bring it back to a neutral position. Yet, as long as the gear ratio is engaged, the idler pinion is under pressure and it is impossible to declutch the sliding gear from said idler pinion. The guide finger of the fork, which continues to follow the track, shifts into the aperture of the core, and compresses one of the springs in said core, which is then temporarily under stress. As soon as the upper gear ratio is engaged, the idler pinion of the previous gear ratio will start rotating less quickly than the shaft carrying said idler pinion and the pressure on the sliding gear will then be released. The claws of said sliding gear and the claws of the idler pinion are then naturally uncoupled.

Thanks to its elasticity, the compressed spring will automatically return to its rest state, causing movement of the core of the fork along the guide axis, and therefore movement of the blade of the fork and of the associated sliding gear. Thus, said sliding gear is spaced apart laterally from the idler pinion and brought back into its neutral position after declutching from the idler pinion. Said idler pinion becomes free in rotation relative to the shaft that carries it.

Thus, the elasticity of the spring enables the sliding gear, which should be uncoupled from the idler pinion, to return to its neutral position, to wait for the pressure on said idler pinion to be released, smoothly, without effort and naturally.

In particular embodiments of the invention, in a subassembly, the idler pinion or the two idler pinions comprise(s) the elastic return means.

In particular embodiments of the invention, when the idler pinion or the two idler pinions comprise(s) the elastic return means, each idler pinion comprises an outer portion, including a bearing lateral face, and a central portion intended to be inserted into the outer portion, said central portion being provided with claws, said central portion being linked in rotation to the outer portion but free in translation. The elastic return means is in the form of a spring positioned between the bearing lateral face of the outer portion and the central portion. Preferably, the spring is fixedly held at one end of the outer portion and at another end to the central portion. In these particular forms, the blade of the fork is a rigid blade.

Thus, to engage a gear ratio, one of the sliding gears is moved, by the associated fork, towards the idler pinion of the gear forming the desired gear ratio, to declutch it.

When the claws of said sliding gear arrive at the claws of the idler pinion, if the claws cannot cooperate together because they are not in-phase with one another, the central portion of the idler pinion is pushed by the sliding gear towards the inside of the outer portion of the idler pinion, compressing the spring. Said spring is then compressed, and therefore under stress. As soon as the claws of the sliding gear and those of the idler pinion are in-phase, the spring will return to its rest state, exerting a force on the central portion to push it towards the sliding gear, making them clutch together and engage the desired gear ratio.

The elasticity of the spring enables the sliding gear, which should be coupled with an idler pinion, to wait for phasing of the different claws and that being so, without effort.

Similarly, to disengage a previous gear ratio, the sliding gear which is clutched to the idler pinion of the gear forming said gear ratio is moved, by the fork, to bring it back into a neutral position. Yet, as long as the gear ratio is engaged, the idler pinion is under pressure and it is impossible to declutch the sliding gear from said idler pinion. The central portion of the idler pinion is driven with the sliding gear, causing a slight stretching of the spring.

As soon as the upper gear ratio is engaged, the idler pinion of the previous gear ratio will start rotating less quickly than the shaft carrying said idler pinion and the negative pressure (tension thanks to anchoring of the ends of the spring), on the sliding gear will then be released. The claws of said sliding gear and the claws of the idler pinion are then naturally uncoupled. The spring will return to its rest state, exerting a return force on the central portion of said idler pinion to move it away from the sliding gear and bring it back into the outer portion of said idler pinion. The idler pinion becomes again free in rotation relative to the shaft that carries it.

Thus, the elasticity of the spring enables the sliding gear, which should be uncoupled from the idler pinion, to return to its neutral position, to wait for the negative pressure on said idler pinion to be released, smoothly, without effort and naturally.

In a particular variant of the invention, in a subassembly, like the idler pinion, the sliding gear comprises the elastic return means. The sliding gear comprises an outer portion, comprising a bearing lateral face, and a central portion intended to be inserted into the outer portion, said central portion being provided with claws, said central portion being linked in rotation to the outer portion but free in translation. The elastic return means is in the form of a spring positioned between the bearing lateral face of the outer portion and the central portion. Preferably, the spring is fixedly held at one end of the outer portion and at another end at the central portion. In these particular embodiments, the blade of the fork is a rigid blade.

In particular embodiments of the invention, in a subassembly, the guide member comprises the elastic return means.

In particular embodiments of the invention, the guide member comprises:
an annular part affixed on the control barrel, fixedly connected in rotation to said control barrel but movable in translation according to a barrel axis and over a predefined distance, said annular part comprising a track extending over a circumferential surface of the latter,
at least one spring arranged against said annular part, at least at a lateral face of said annular part, said at least one spring being connected, at one end, to said annular part and, at another end, to a fixed stop on the control barrel, the at least one spring forming the elastic return means.

In these particular embodiments, the blade of the fork is preferably a rigid blade.

In a preferred embodiment, the guide member comprises two springs, each spring being arranged on either side of the annular part, at the level of opposite lateral faces of said annular part. Each spring is connected, at one end, to said annular part and, at another end, to a fixed stop on the control barrel. Said two springs form the elastic return means.

Thus, in order to engage a gear ratio, one of the sliding gears is moved, by the associated fork, towards the idler pinion of the gear forming the desired gear ratio, to clutch it.

When the claws of said sliding gear arrive at the claws of the idler pinion, if the claws cannot cooperate together because they are not in-phase with one another, the translation of the sliding gear is blocked, simultaneously blocking the translation of the fork. The guide finger of the fork, continuing to follow the track of the guide member, causes a lateral offset of the annular part, compressing or stretching at least one spring, depending on the positioning of each spring with respect to the annular part. Said at least one spring is then under stress. As soon as the claws of the sliding gear and those of the idler pinion are in-phase, the spring will return to its rest state, causing movement of the annular part on the control barrel, and consequently causing movement of the fork, and therefore movement of the associated sliding gear. Thus, the sliding gear is pushed towards the idler pinion, making them clutch together and engage the desired gear ratio.

The elasticity of at least one spring enables the sliding gear, which should be coupled with an idler pinion, to wait for phasing of the different claws and that being so without effort.

Similarly, to disengage a previous gear ratio, the sliding gear which is clutched to the idler pinion of the gear forming said gear ratio is moved, by the fork, to bring it back into a neutral position. Yet, as long as the gear ratio is engaged, the idler pinion is under pressure and it is impossible to declutch the sliding gear from said idler pinion. The movement of the sliding gear is temporarily blocked, simultaneously blocking the movement of the fork. The guide finger of the fork, continuing to follow the track of the associated guide member, causes an offset of the annular part, stretching or compressing at least one spring. The at least one spring is then temporarily under stress.

As soon as the upper gear ratio is engaged, the idler pinion of the previous gear ratio will be able to rotate less quickly than the shaft carrying said idler pinion and the pressure on the sliding gear will then be released. The claws of said sliding gear and the claws of the idler pinion are then naturally uncoupled.

By its elasticity, at least one spring will automatically return to its rest state, causing movement of the annular part on the control barrel, and consequently driving the fork, and therefore movement of the associated sliding gear. Thus, said sliding gear is spaced apart from the idler pinion. Said idler pinion becomes again free in rotation relative to the shaft that carries it.

Thus, the elasticity of the at least one spring enables the sliding gear, which should be uncoupled from the idler pinion, to return to its neutral position, to wait for the negative pressure on said idler pinion to be released, smoothly, without effort and naturally.

In particular embodiments of the invention, the claws of the sliding gears and of the idler pinions of the gear selection system are complementary wolf teeth-type claws.

The wolf teeth have a sawtooth-like general shape having two adjacent sides forming therebetween an angle smaller than or equal to 90°.

The wolf teeth of a sliding gear are configured, on the one hand, to grip the wolf teeth of the idler pinion with which it cooperates, causing the rotational drive of the shaft carrying said idler pinion and, on the other hand, to escape in the opposite direction, like freewheel pawls.

Preferably, the wolf teeth-type claws are suited for a gearbox intended for use on cycles provided with a crankset, with or without an electric motor.

In particular embodiments of the invention, the claws of the sliding gears and of the idler pinions of the gear selection system are in the form of tenons, preferably with a trapezoidal section.

Preferably, the tenon claws are suited for a gearbox intended for use on vehicles provided with a heat engine and using an engine brake.

In particular embodiments of the invention, the idler pinion or the two idler pinions of a subassembly comprise(s) protruding elements between the tenon claws. Advantageously, such protruding elements allow contributing to the ejection of the sliding gear off the idler pinion after declutching.

In particular embodiments of the invention, the gearbox comprises an anti-neutral blocking system. Advantageously, such an anti-neutral blocking system allows blocking the switch from the first gear ratio into the neutral point and vice versa. Unblocking being possible only by an intentional action of a user.

In particular embodiments of the invention, in order to improve the reliability and the safety of the gearbox, said gearbox comprises, when a sliding gear cooperates with one or two idler pinion(s), spacer elements for maintaining the spacing between said idler pinions. Advantageously, such spacer elements replace the clip grooves, and therefore the clips or circlips, conventionally used. The clip grooves, made by removing material in the shaft carrying the idler pinions, are the source of breakage primers, weakening said shaft.

### BRIEF DESCRIPTION OF THE FIGURES

The invention will be better understood upon reading the following description, given as a non-limiting example, and made with reference to the following figures:

FIG. 1 illustrates an electrically-assisted bicycle provided with a gearbox of the invention according to a first version, the gearbox being concealed in a protective case,

FIG. 2 shows the electrically-assisted bicycle of FIG. 1, with the gearbox apparent,

FIG. 3 shows an enlarged view of the gearbox of FIG. 2,

FIG. 4 shows a top view of the gearbox of FIG. 3,

FIG. 5 shows a cross-sectional view of the gearbox of FIG. 4 according to the line AA,

FIG. 6 shows a perspective view of a sliding gear of a subassembly of the gearbox,

FIG. 7 shows a perspective view of a blade of a fork of a subassembly of the gearbox,

FIG. 8 shows a front view of a barrel and the flat pattern of its tracks,

FIG. 9 shows a perspective view of a variant of a fork of a subassembly of the gearbox,

FIG. 10 shows a side view of the fork of FIG. 9,

FIG. 11 shows a perspective view of another variant of a fork of a subassembly of the gearbox,

FIG. 12 shows a side view of the fork of FIG. 11,

FIG. 13 shows a rear view of the fork of FIG. 11,

FIG. 14 shows a cross-sectional view of the fork of FIG. 13 according to the line AA,

FIG. 15 shows a perspective view of a variant of an idler pinion of a subassembly of the gearbox,

FIG. 16 shows an exploded view of the idler pinion of FIG. 15,

FIG. 17 shows a perspective view of the gearbox according to the invention, according to a second version,

FIG. 18 shows a ¾ front view of the gearbox of FIG. 17, concealed in its protective casings,

FIG. 19 shows a top view of the gearbox of FIG. 18, with the protective casings,

FIG. 20 shows a side view of the gearbox of FIG. 18, with the protective casings,

FIG. 21 shows a cross-sectional view of the gearbox, with the protective casings of FIG. 20 according to the line AA,

FIG. 22 shows a cross-sectional view of the gearbox, with the protective casings of FIG. 20 according to the line BB,

FIG. 23 shows a cross-sectional view of the gearbox, with the protective casings of FIG. 20 according to the line CC,

FIG. 24 shows a variant of a fork of a subassembly of the gearbox of FIG. 17,

FIG. 25 shows a perspective view of a variant of an idler pinion of a subassembly of the gearbox of FIG. 17,

FIG. 26 shows a side view of the idler pinion of FIG. 25,

FIG. 27 shows a perspective view of a sliding gear adapted to be coupled with the idler pinion of FIG. 25.

In these figures, identical reference numerals from one figure to another designate identical or similar elements. Moreover, for clarity, the drawings are not plotted to scale, unless stated otherwise.

### DETAILED DESCRIPTION OF THE EMBODIMENTS

A gearbox 1 according to the invention is now described according to two versions. Regardless of the version, the gearbox 1 according to the invention advantageously enables gear shifts with no break in torque, whether during an acceleration, by a gear shift to the upper gear, or during a deceleration, by a gear shift to the lower gear and/or a downshift with engine braking.

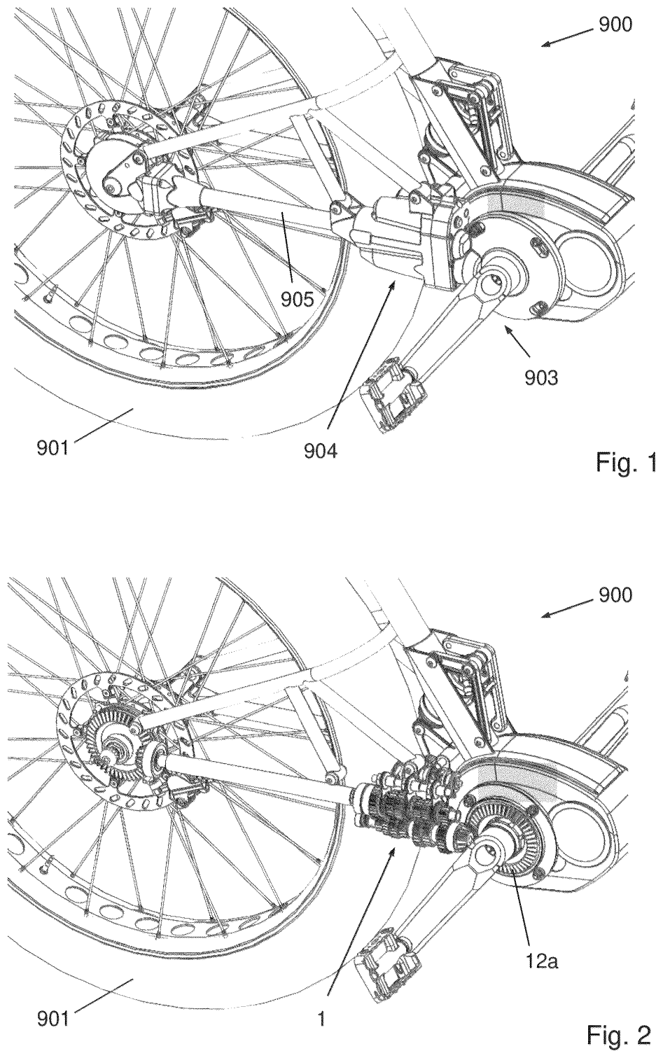

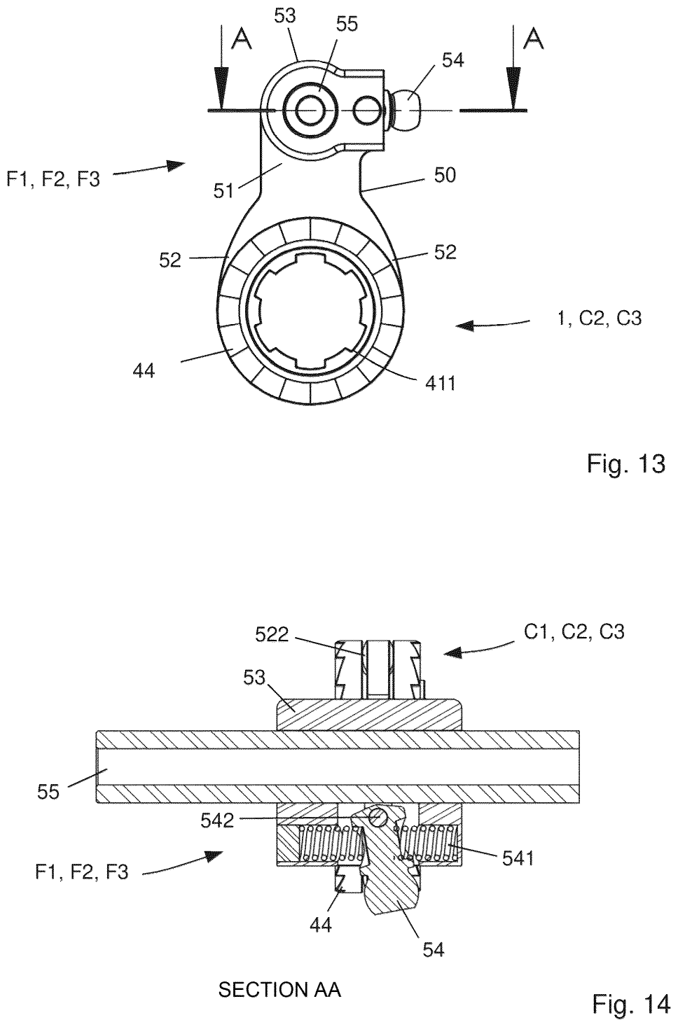

In the first version, the gearbox 1 is suitable for use on cycles provided with a crankset, with or without an electric motor (of the electrically-assisted bicycle type, known under the acronym VAE). FIGS. 1 to 16 illustrate, in a non-limiting manner, the use of the gearbox 1 for an electrically-assisted bicycle.

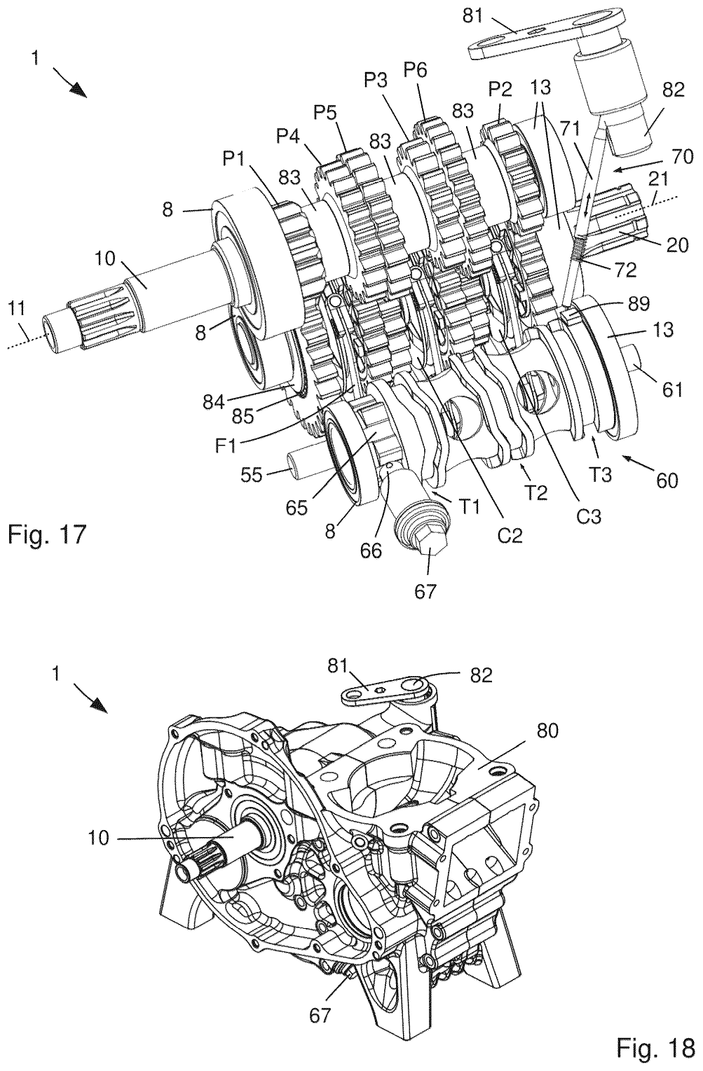

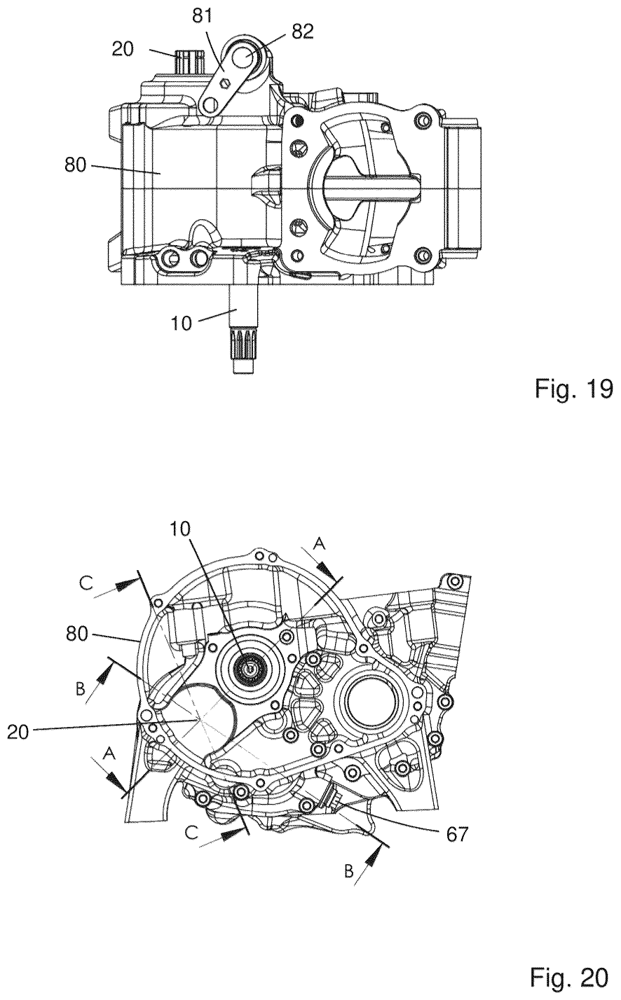

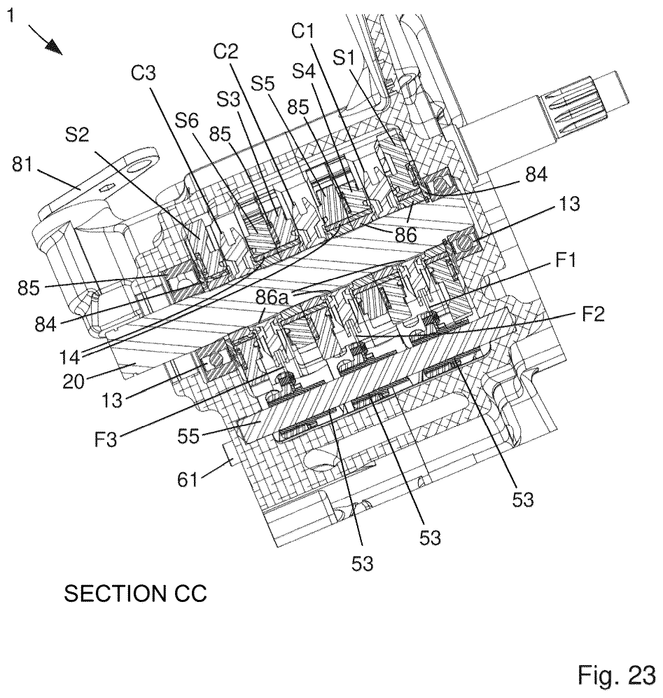

In a second version, the gearbox 1 is suitable for use on vehicles provided with a heat engine and using an engine brake, such as for example a kart, a motorcycle, a car. FIGS. 17 to 27 illustrate, in a non-limiting manner, the use of the gearbox 1 for a kart engine.

In the two versions that will be described, the gearbox 1 is a six-gear gearbox. Nevertheless, the number of gear ratios does not limit the invention. Thus, it is possible to adapt the gearbox to the desired number of gear ratios, whether this number is even or odd.

### First Version of the Gearbox

FIGS. 1 and 2 show an electrically-assisted bicycle 900, more specifically the rear portion thereof, on which the gearbox 1 according to the invention is installed.

The gearbox 1 is intended to be positioned between a rear wheel 901 and an electric motor 902, in connection with a crankset 903.

In FIG. 1, the gearbox 1 is concealed in a protective case 904. In FIG. 2, the protective case 904 has been removed to reveal said gearbox.

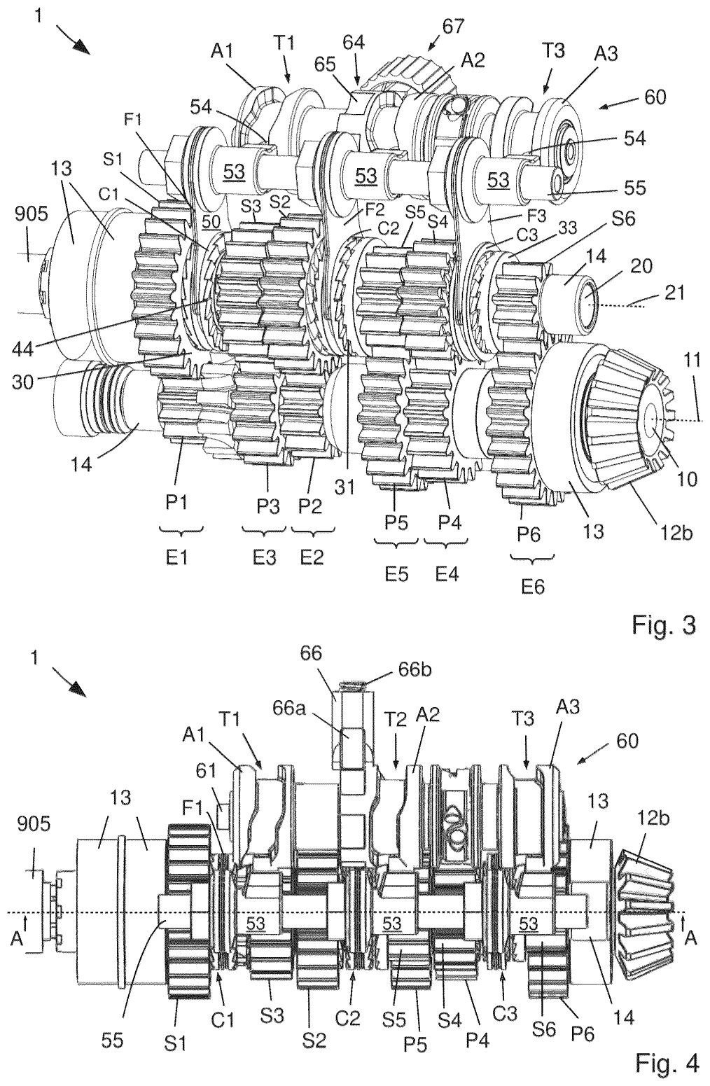

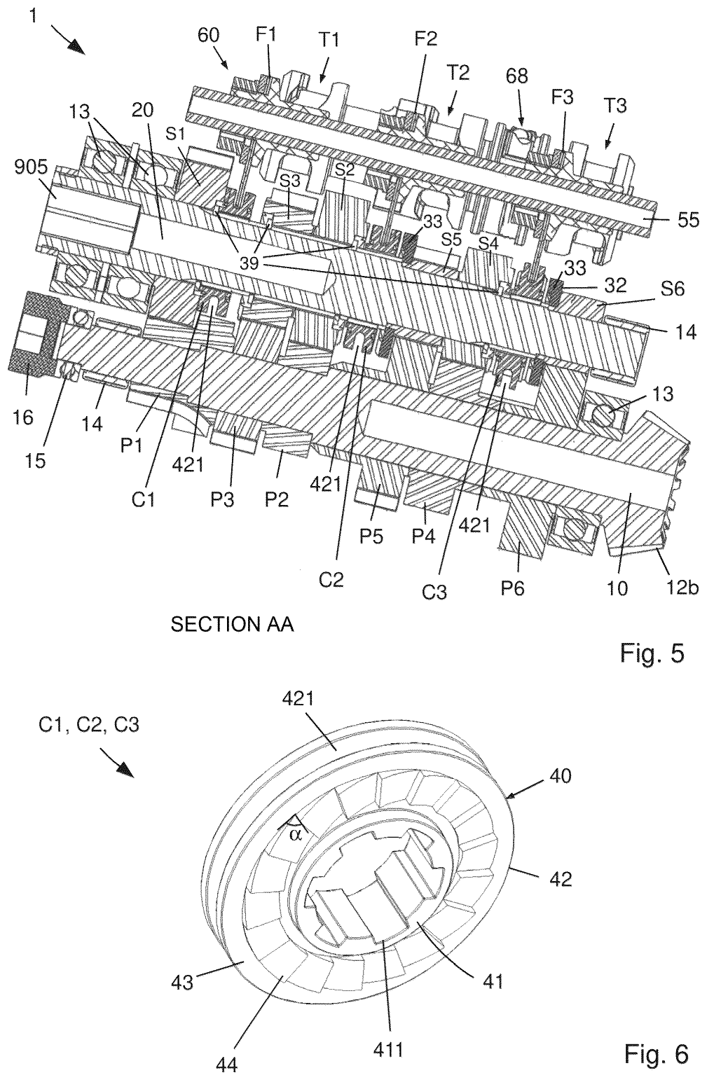

The gearbox 1 is illustrated in detail in FIGS. 3 to 5. FIG. 3 shows an enlarged view of the gearbox of FIG. 2 FIG. 4 shows a top view of the gearbox of FIG. 3. FIG. 5 shows a cross-sectional view of the gearbox of FIG. 4 according to line AA.

The gearbox 1 comprises a first shaft, so-called the primary shaft 10. The primary shaft 10 has, as an axis of rotation, an axis so-called the first axis of rotation 11. The primary shaft 10 extends according to said first axis of rotation. The primary shaft 10 is configured to be driven in rotation about said first axis of rotation.

Preferably, the primary shaft 10 is guided in rotation about said first axis of rotation by ball bearings 13 and/or needle bearings 14, arranged for example at the two longitudinal ends of the primary shaft.

In this first version, the primary shaft 10 is intended and configured to be connected to the engine output, most often coaxial with the crankset 903, of the electrically-assisted bicycle 900, via an angle bevel gear. For example, the angle bevel gear is formed by a crown with a conical toothing 12a and a pinion with a conical toothing 12b, with substantially perpendicular axes, engaged with one another.

In one embodiment, the bevel pinion 12b drives the primary shaft 10 in the clockwise direction, when viewed in the direction of advance of the electrically-assisted bicycle.

Preferably, the clearance between the teeth of the angle bevel gear may be meticulously adjusted by means of a needle stop 15 accurately positioned by the support of a fine-pitch screw 16, as illustrated in FIG. 5.

The gearbox 1 further comprises a second shaft, so-called the secondary shaft 20. The secondary shaft 20 has, as an axis of rotation, an axis so-called the second axis of rotation 21. The secondary shaft 20 extends according to said second axis of rotation. The secondary shaft 20 is configured to be driven in rotation about the second axis of rotation 21. Preferably, said second axis of rotation is distinct from the first axis of rotation 11. Thus, the secondary shaft 20 is parallel to the primary shaft 10, and non-coaxial therewith.

Preferably, the secondary shaft 20 is guided in rotation about said second axis of rotation by ball bearings 13 and/or needle bearings 14, arranged for example at the two longitudinal ends of the secondary shaft 20.

In this first version of the gearbox, the secondary shaft 20 is intended and configured to be connected to the rear wheel 901 of the electrically-assisted bicycle 900. A transmission shaft 905 and an angle bevel gear (visible in FIG. 2) allow, for example, ensuring connection between the secondary shaft 20 and the rear wheel 901, as illustrated in FIG. 1. In the example of FIG. 1, the secondary shaft 20 is connected directly to the transmission shaft 905 and the latter is connected to the rear wheel 901 by the angle bevel gear.

In another embodiment, the secondary shaft may be connected to a pinion cooperating with a chain or a belt, notched or not.

The secondary shaft 20 is configured to rotate in the direction opposite to that of the primary shaft 10.

The primary shaft 10 and the secondary shaft 20 are connected together via gears E1, E2, E3, E4, E5, E6 forming distinct gear ratios.

Preferably, the number of gears is even.

Preferably, the gearbox 1 comprises at least four gears.

In the examples illustrated in the figures, yet not limiting the invention, the primary shaft 10 and the secondary shaft 20 are connected together by six successive gears E1, E2, E3, E4, E5, E6, forming six distinct gear ratios.

Each gear E1, E2, E3, E4, E5, E6 is formed by a gear wheel, P1, P2, P3, P4, P5, P6, driven in rotation by one of the two shafts, and an idler pinion S1, S2, S3, S4, S5, S6, mounted on the other shaft, which mesh with one another.

The wheels P1, P2, P3, P4, P5, P6 are aligned next to one another over a portion of the length of the shaft that carries them. Each of the wheels P1, P2, P3, P4, P5, P6 meshes with one of the idler pinions S1, S2, S3, S4, S5, S6 aligned in correspondence over a portion of the length of the shaft carrying said idler pinions. Each wheel P1, P2, P3, P4, P5, P6 is constantly meshed with the associated idler pinion S1, S2, S3, S4, S5, S6.

Each wheel P1, P2, P3, P4, P5, P6 is fixedly linked in rotation and in translation with the shaft that carries it.

Each idler pinion S1, S2, S3, S4, S5, S6 is fixedly linked in translation and mounted free in rotation on the shaft that carries it.

In the described embodiment, and without this limiting the invention, all wheels P1, P2, P3, P4, P5, P6 are arranged on the primary shaft 10 and all idler pinions S1, S2, S3, S4, S5, S6 are arranged on the secondary shaft 20.

In one embodiment, illustrated in FIGS. 3 and 4, yet not limiting the invention, the wheels and idler pinions have a straight toothing.

In another embodiment, and without departing from the scope of the invention, the gear wheels and the idler pinions have a helical or epicyclical toothing, etc.

In one embodiment, circlips 39 enable lateral holding of the idler pinions on the secondary shaft 20.

Each gear E1, E2, E3, E4, E5, E6 defines a gear ratio with a clean reduction ratio.

Thus, for example, and as illustrated in FIG. 3, the first gear ratio has the lowest reduction ratio. It is formed by a first wheel P1 and a first idler pinion S1. The first wheel P1 has the smallest pitch diameter among the plurality of wheels and the first idler pinion S1 has the largest pitch diameter among the plurality of idler pinions. The second gear ratio has a greater reduction ratio than the first ratio and is formed by a second wheel P2 and a second idler pinion S2. The third gear ratio has a greater reduction ratio than the second gear ratio and is formed by a third wheel P3 and a third idler pinion S3. The fourth gear ratio has a greater reduction ratio than the third ratio and is formed by a fourth wheel P4 and a fourth idler pinion S4. The fifth gear ratio has a greater reduction ratio than the fourth ratio and is formed by a fifth wheel P5 and a fifth idler pinion S5. Finally, the sixth gear ratio, which has the highest reduction ratio and which is formed by a sixth wheel P6 and a sixth idler pinion S6. The sixth wheel P6 has the largest pitch diameter among the plurality of wheels and the sixth idler pinion S6 has the smallest pitch diameter among the plurality of idler pinions.

Each idler pinion S1, S2, S3, S4, S5, S6 comprises claws 31 at the level of one of its lateral faces 32.

In one embodiment, the claws 31 are formed on a lateral face of the annular element 30 forming said idler pinion. Such an embodiment is visible in FIGS. 4 and 5 for the first, second, third and fourth idler pinions S1, S2, S3, S4.

In another embodiment, to overcome the reduced diameters of the idler pinions, the claws 31 are formed on a flange 33 fastened on a lateral face 32 of the annular element 30 forming said idler pinion. Such an embodiment is visible in FIGS. 4 and 5 for the fifth and sixth idler pinions S5, S6.

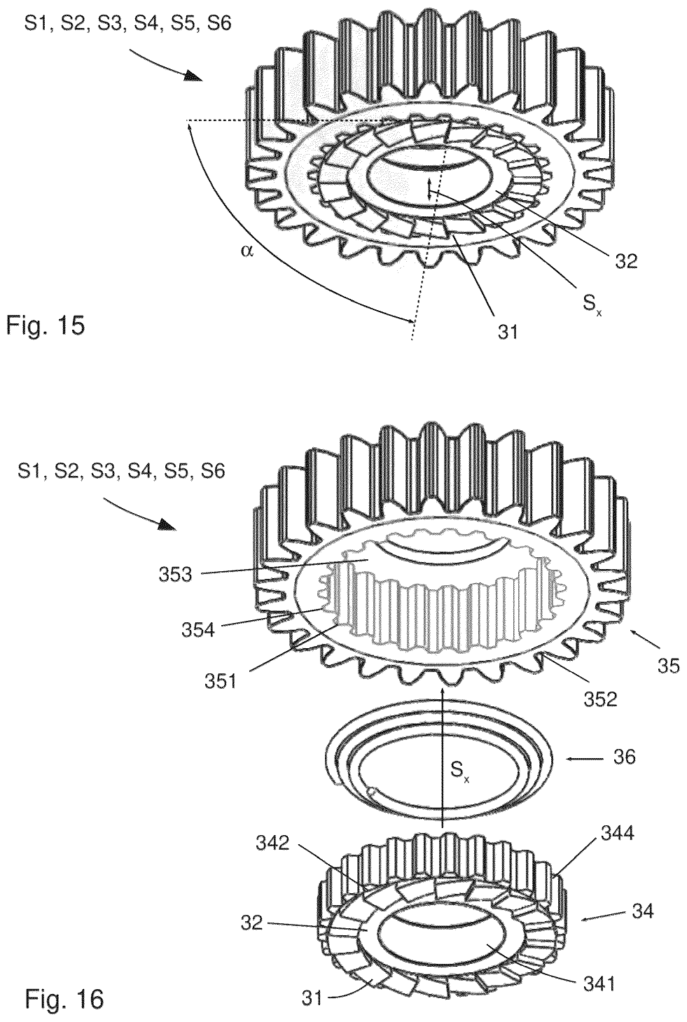

In a preferred embodiment of the claws, as illustrated in FIG. 15, the claws 31 are in the form of wolf teeth.

The wolf teeth have a sawtooth-like general shape having two adjacent sides forming therebetween an angle smaller than or equal to 90°.

The gearbox 1 further comprises sliding gears C1, C2, C3 and forks F1, F2, F3, adapted to participate in shifting of the gear ratios.

There are as many sliding gears as forks in the gearbox.

A sliding gear C1, C2, C3 is configured to mechanically connect an idler pinion S1, S2, S3, S4, S5, S6 in rotation to the shaft that carries it, upon engagement of a gear ratio.

A sliding gear C1, C2, C3 is fixedly linked in rotation to the shaft that carries it and movable in translation on said shaft, according to the axis of rotation of said shaft, to enable gripping thereof with the adjacent idler pinion. Next, the term “clutch” will be used when a sliding gear is in cooperation with an idler pinion so that a gear ratio is engaged. The term “declutch” will be used when a sliding gear is cleared from the idler pinion so that the gear ratio is disengaged.

Preferably, each sliding gear C1, C2, C3 is configured to be able to be associated with two consecutive idler pinions of the same shaft.

Thus, each sliding gear C1, C2, C3 is linked in rotation to the shaft carrying the two idler pinions, in the example to the secondary shaft 20, and movable in translation on said secondary shaft, according to the second axis of rotation, according to two directions.

In other words, the gear ratios are assembled in pairs with a sliding gear C1, C2, C3 which engages, on the one hand, one of the two associated idler pinions by moving in one direction and, on the other hand, the other idler pinion moving in the other direction.

Preferably, these pairs of idler pinions are arranged in a manner allowing engaging two numerically successive gear ratios with different sliding gears.

In a first embodiment of the arrangement of the gears, not limiting the invention, and as illustrated in FIGS. 3 to 5, the idler pinions are successively mounted on the secondary shaft in the following order: S1, S3, S2, S5, S4, S6. Similarly, the wheels are successively fastened on the primary shaft in the following order: P1, P3, P2, P5, P4, P6. Hence, the gear ratios are in the following order: 1^{st}, 3^{rd}, 2^{nd}, 5^{th}, 4^{th}, 6^{th}. Thanks to this arrangement, it is possible to temporarily engage two successive gears at the same time, in order not to have a break in the torque in the transmission of the engine movement.

Thus, the sliding gears C1, C2, C3 are three in number in this example and so-called first, second and third sliding gear. They are all mounted on the secondary shaft 20 and are respectively positioned between the first and third idler pinions S1, S3, the second and fifth idler pinions S2, S5 and the fourth and sixth idler pinions S4, S6. The sliding gears C1, C2 and C3 respectively allow engaging the 1^{st} and 3^{rd} gears, the 2^{nd} and 5^{th} gears, and the 4^{th} and 6^{th} gears.

Each sliding gear C1, C2, C3 comprises an annular element 40 having an inner periphery 41 and an outer periphery 42.

In one embodiment, illustrated in FIG. 6, each sliding gear comprises, at the inner periphery 41, longitudinal splines 411 evenly distributed over the circumference of said inner periphery. These longitudinal splines 411 are intended to cooperate with complementary longitudinal splines (not shown) evenly distributed over the circumference of an external surface of the secondary shaft 20, at least at a movement area of said sliding gear.

Advantageously, these longitudinal splines 411 enable the translation but block the rotation of the sliding gear C1, C2, C3 relative to the secondary shaft 20 with which it is associated.

Each sliding gear comprises, at the outer periphery 42, a circular groove 421 intended to receive a fork.

Each sliding gear comprises claws 44 at the level of lateral faces 43. The claws 44 of a lateral face 43 of a sliding gear are complementary to the claws 31 of the idler pinion located opposite said lateral face and are intended to cooperate with said claws of said idler pinion.

Advantageously, each sliding gear C1, C2, C3 is able to take on at least three different positions: a neutral position and two clutched positions.

In the neutral position, the sliding gear is positioned between the two associated adjacent idler pinions such that it is cleared from the gear ratios. The claws 44 of each lateral face 43 of the sliding gear are positioned at a distance from the claws 31 of each idler pinion facing one another.

In one clutched position, the sliding gear is clutched with one of the two associated idler pinions, so as to engage the associated gear ratio.

In the other clutched position, the sliding gear is clutched with the other associated idler pinion so as to engage the associated gear ratio.

In one embodiment, illustrated in FIGS. 3 to 5, the first sliding gear C1 is in the clutched position with the first idler pinion S1. The second and third sliding gears C2, C3 are in the neutral position. Thus, the 1^{st} gear ratio is engaged.

In a preferred embodiment of claws of a sliding gear, the claws 44 are in the form of wolf teeth capable of cooperating with the wolf teeth of the associated idler pinion.

Hence, the wolf teeth 44 of a lateral face 43 of a sliding gear are complementary to the wolf teeth 31 of the associated idler pinion. The wolf teeth 44 of a lateral face 43 of a sliding gear are inclined so as to achieve a unidirectional freewheel coupling. The wolf teeth 31 of the idler pinion grip the wolf teeth 44 of a lateral face 43 of an associated sliding gear, causing the rotational drive of said secondary shaft and escape in the opposite direction, like freewheel pawls.

The wolf teeth of a sliding gear or of an idler pinion have a sawtooth-like general shape having two adjacent sides forming therebetween an angle smaller than or equal to 90° and an angle α (illustrated in FIG. 15 for the idler pinion and in FIG. 6 for the sliding gear) between the lateral face (referenced 32 for the idler pinion and 43 for the sliding gear) and a perpendicular to the second axis of rotation 21, smaller than or equal to 90°, preferably smaller. Advantageously, this angle α determines the coupling connection force of an idler pinion with a sliding gear.

In turn, the forks F1, F2, F3 ensure the translational movements of the sliding gears C1, C2, C3, a fork cooperating with a sliding gear. Thus, a first fork F1 cooperates with the first sliding gear C1, a second fork F2 cooperates with the second sliding gear C2, a third fork F3 cooperates with the third sliding gear C3.

The forks F1, F2, F3 are configured to slide in translation on a guide axis 55. Preferably, said guide axis is parallel to the primary 10 and secondary 20 shafts, in a non-coaxial manner. For example, said guide axis may be a profile such as a rod with a circular cross-section, as illustrated in FIG. 3.

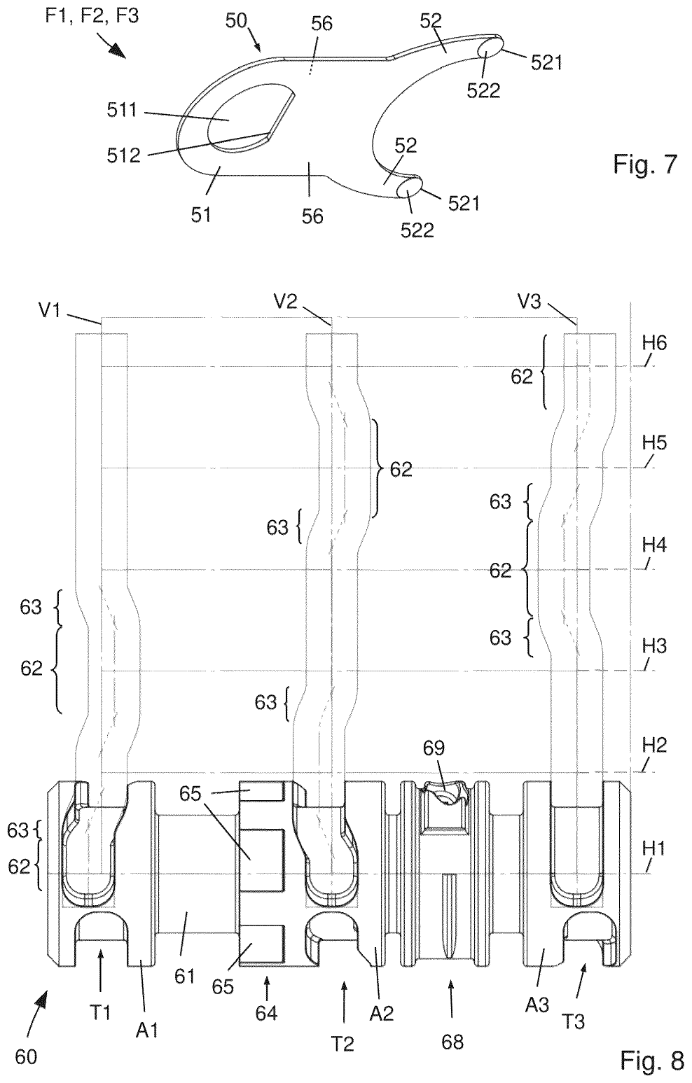

Preferably, each fork F1, F2, F3 comprises, as illustrated in FIG. 7, a blade 50 comprising a body 51 and two branches 52 connected to said body. The body 51 of each fork F1, F2, F3 comprises, across its thickness, a through orifice 511 throughout which the guide axis 55 can pass. The two branches 52 have free ends 521 intended to engage, with some clearance, in the circular groove 421 of the associated sliding gear C1, C2, C3.

Each fork F1, F2, F3 further comprises a core 53 comprising a through bore 531 intended to receive the guide axis 55. Said core and the body 51 of said blade are fixedly linked to one another.

Advantageously, the through orifice 511 comprises, as illustrated in FIG. 7, a foolproof device 512 allowing facilitating the assembly of the blade and of the core to guarantee the relative positioning thereof and consequently the correct positioning thereof in the gearbox.

Each fork F1, F2, F3 further comprises a guide finger 54 intended to be connected to a control barrel 60. Preferably, and as illustrated in FIGS. 3 and 4, said guide finger of a fork F1, F2, F3 is fixedly linked to the core 53. In another embodiment, the guide finger 54 and the core 53 form a single-piece assembly.

The forks F1, F2, F3 are driven in translation along the guide axis 55, via the guide fingers 54, by the control barrel 60.

For example, the control barrel 60, or more simply the barrel, is, as illustrated in FIGS. 3 and 8, an element with a cylindrical general shape, with a circular cross-section. The barrel 60 is guided in rotation about an axis called barrel axis 61. Preferably, said axis of the barrel is parallel to the guide axis 55 of the forks F1, F2, F3.

The barrel 60 comprises guide members. Each guide member is configured to guide a guide finger 54 of a fork F1, F2, F3.

In one embodiment, the guide members are tracks T1, T2, T3. Each track T1, T2, T3 is configured to receive a guide finger 54 of a fork F1, F2, F3.

Each track T1, T2, T3 extending globally over a circumferential surface of the barrel 60.

In a preferred embodiment, each track T1, T2, T3 is in the form of a groove formed in the barrel, extending from the circumferential surface of the barrel 60.

In another embodiment, illustrated in FIGS. 3-5, 8, the guide members comprise parts, called annular parts A1, A2, A3, affixed on the barrel. These annular parts A1, A2, A3 are fixedly linked or not to, and possibly made in one-piece with, the barrel 60. The annular parts illustrated in FIGS. 3-5, 8 are independent of one another. For example, each annular part A1, A2, A3 is in the form of an annular element arranged around the barrel. Each annular part A1, A2, A3 comprises a track T1, T2, T3.

Each track T1, T2, T3 extends generally over a circumferential surface of the associated annular part A1, A2, A3.

In a preferred embodiment, each track T1, T2, T3 is in the form of a groove formed in the associated annular part A1, A2, A3, extending from the circumferential surface of said annular part.

In the example illustrated in FIGS. 3-5, 8, the barrel 60 comprises three annular parts A1, A2, A3, each annular part A1, A2, A3 comprising a track. The annular parts A1, A2, A3 are fixedly connected to the barrel 60.

In the example illustrated in FIGS. 3-5, 8, the barrel 60 comprises three tracks, one track per guide finger 54 of a fork. Thus, a first track T1 is associated with the first fork F1, a second track T2 with the second fork F2 and a third track T3 with the third fork T3.

Each track T1, T2, T3 consists of different sections. Some sections, called straight sections 62, extend in a plane perpendicular to the barrel axis 61, whereas other sections, so-called ramp or cam sections 63, extend in a plane that is inclined with respect to the barrel axis 61.

Advantageously, each of the tracks T1, T2, T3 forms a guide for the guide finger 64 of the associated fork F1, F2, F3. In other words, the tracks T1, T2, T3 actually direct the movement of the guide fingers 54 of the forks F1, F2, F3, and therefore the movement of the forks F1, F2, F3 along the guide axis and consequently the movement of the associated gears C1, C2, C3.

The rotation of the barrel 60 about the barrel axis 61 is performed for example by maneuvering means arranged on the barrel.

For example, and as illustrated in FIGS. 3, 4 and 8, these maneuvering means consist of a pulley 68, serving as a capstan, which receives a pair of cables 69 movable in both directions. Preferably, the cables 69 are connected to a fear selector (not shown in the figures) arranged at a handlebar of the electrically-assisted bicycle 900, for example.

In this example, the maneuvering means advantageously allow rotating the barrel 60 about the barrel axis 61, in both directions of rotation, with one single command.

The rotation of said barrel 60 about the barrel axis 61 simultaneously brings each fork guide finger 54 into a section of the associated track. When a guide finger 54 of a fork F1, F2, F3 is located in a straight section 62, the rotation of the barrel 60 does not impose any translational movement of the guide finger 54, and therefore no translation of said fork along its guide axis. When a guide finger 54 of a fork F1, F2, F3 is located in a ramp section 63, the rotation of the barrel 60, by a cam effect, causes a translation of the guide finger 54 and consequently a translation of said fork along its guide axis 12.

FIG. 8 shows, for illustration, a barrel 60 and the flat pattern of the tracks T1, T2, T3 for a gearbox 1 whose gears are successively arranged like in FIGS. 2 to 4, namely E1, E3, E2, E5, E4 and E6.

The arrangement of the tracks T1, T2, T3 of the barrel 60 allows obtaining the 6 gear ratios.

The first track T1 (the leftmost track in FIG. 8) enables the translational movement of the first fork F1, via its guide finger 54, and of the associated first sliding gear C1, so as to engage the 1^{st} or 3^{rd} gear ratios. The second track T2 enables the translational movement of the second fork F2, via its guide finger, and of the associated second sliding gear C2, so as to engage the 2^{nd} or 5^{th} gear ratios. The third track T3 enables the translational movement of the third fork F3, via its guide finger, and of the associated third sliding gear C3, so as to engage the 4^{th} or 6^{th} gear ratios.

1^{st} gear ratio (corresponding to the positioning of the sections of the tracks as shown by a first horizontal line H1 in FIG. 8):
the straight section 62 of the first track T1 is offset transversely (to the left in the figure) relative to a median position (represented by a first vertical line V1 in FIG. 8) of the first track T1: this means that the first sliding gear C1 is in the clutched position with the first idler pinion S1; the third idler pinion S3 is free in rotation around the secondary shaft 20,
the straight section 62 of the second track T2 is located at a median position (represented by a second vertical line V2 in FIG. 8) of the second track T2: the second sliding gear C2 is in the neutral position; the second and fifth pinions S2, S5 are free in rotation around the secondary shaft 20,
the straight section 62 of the third track T3 is located at a median position (represented by a third vertical line V3 in FIG. 8) of the third track T3: the third sliding gear C3 is in the neutral position; the fourth and sixth idler pinions S4, S6 are therefore free in rotation around the secondary shaft 20.

2^{nd} gear ratio (corresponding to the positioning of the sections of the tracks as shown by a second horizontal line H2 in FIG. 8):
the straight sections 62 of the first and third tracks T1, T3 are located at the median position of their respective tracks: the first and third sliding gears C1, C3 are in the neutral position; the first, third, fourth and sixth idler pinions S1, S3, S4, S6 are therefore free in rotation around the secondary shaft 20,
the straight section 62 of the second track T2 is offset transversely (to the left in the figure) relative to the median position of the second track T2: the second sliding gear C2 is clutched with the second idler pinion S2; the fifth idler pinion S5 is free in rotation around the secondary shaft.

One could notice, on the flat pattern of FIG. 8, that between the 1^{st} and the 2^{nd} gear ratios (i.e. between the first and second horizontal lines H1, H2), a ramp section 63 fits between the two straight sections 62 of the first track T1, laterally offsetting the guide finger 54 of the first fork F1 and consequently causing movement of said first fork F1 and of the first sliding gear C1 towards its neutral position. Equivalently, a ramp section 63 fits between the two straight sections 62 of the second track T2, laterally offsetting the guide finger 54 of the second fork F2 and consequently causing movement of said second fork F2 and of the second sliding gear C2 towards a clutched position, herein with the second idler pinion S2.

3^{rd} gear ratio (corresponding to the positioning of the sections of the tracks as shown by a third horizontal line H3 in FIG. 8):
the straight section 62 of the first track T1 is offset transversely (to the right in the figure) relative to the median position of the first track T1: the first sliding gear C1 is clutched with the third idler pinion S3; the first idler pinion S1 is free in rotation around the secondary shaft 20,
the straight sections 62 of the second and third tracks T2, T3 are located at the median position of their respective tracks: the second and third sliding gears C2, C3 are in the neutral position; the second, fourth, fifth and sixth idler pinions S2, S4, S5, S6 are therefore free in rotation around the secondary shaft 20.

4^{th} gear ratio (corresponding to the positioning of the sections of the tracks as shown by a fourth horizontal line H4 in FIG. 8):
the straight sections 62 of the first and second tracks T1, T2 are located at the median position of their respective tracks: the first and second sliding gears C1, C2 are in the neutral position; the first, second, third and fifth idler pinions S1, S2, S3, S5 are therefore free in rotation around the secondary shaft 20,
the straight section 62 of the third track T3 is offset transversely (to the left in the figure) relative to the median position of the third track T3: the third sliding gear C3 is clutched with the fourth idler pinion S4; the sixth idler pinion S6 is free in rotation around the secondary shaft.

5^{th} gear ratio (corresponding to the positioning of the sections of the tracks as shown by a fifth horizontal line H5 in FIG. 8):
the straight sections 62 of the first and third tracks T1, T3 are located at the median position of their respective tracks: the first and third sliding gears C1, C3 are in the neutral position; the first, third, fourth and sixth idler pinions S1, S3, S4, S6 are therefore free in rotation around the secondary shaft 20,
the straight section 62 of the second track T2 is offset transversely (to the right in the figure) relative to the median position of said second track T2: the second sliding gear C2 is clutched with the fifth idler pinion S5; the second idler pinion S2 is free in rotation around the secondary shaft.

6^{th} gear ratio (corresponding to the positioning of the sections of the tracks as shown by a sixth horizontal line H6 in FIG. 8):
the straight sections 62 of the first and second tracks T1, T2 are located at the median position of their respective tracks: the first and second sliding gears C1, C2 are in the neutral position; the first, second, third and fifth idler pinions S1, S2, S3 and S5 are therefore free in rotation around the secondary shaft 20,
the straight section 62 of the third track T3 is offset transversely (to the right in the figure) relative to the median position of said third track T3: the third sliding gear C3 is clutched with the sixth idler pinion S6; the fourth idler pinion S4 is free in rotation around the secondary shaft.

One could observe, on the flat pattern of FIG. 8, between each horizontal line (H1-H6) representing a gear shift, a slight overlap area of the cam sections over two consecutive gear ratios. This arrangement of the tracks also allows not having a break in torque during a gear shift.

In an improved embodiment of the barrel 60, illustrated in FIGS. 3, 4 and 8, said barrel comprises an indexing wheel 64 at the circumferential surface. This indexing wheel 64 comprises recessed portions 65 evenly spaced around the circumference of said barrel. These recessed portions are called indexing notches 65. There are as many indexing notches 65 as gear ratios of the gearbox 1. These indexing notches 65 allow precisely positioning each fork F1, F2, F3, and therefore the associated sliding gear C1, C2, C3, to engage the gear ratio or set it to neutral.

Besides the gear ratios, the gearbox 1 may also comprise a neutral point. This neutral point is characterized by a positioning of all of the sliding gears C1, C2, C3 at the neutral.

Besides the indexing notches 65 for each gear of the gearbox, the indexing wheel 64 of the barrel 60 comprises over the circumference of said barrel an additional indexing notch for positioning at the neutral point. Preferably, this additional indexing notch is formed between the indexing notch for the 1^{st} gear and the indexing notch for the 6^{th} gear. Thus, the gear program is established as follows: 0, 1^{st}, 2^{nd}, 3^{rd}, 4^{th}, 5^{th}, 6^{th}.

These indexing notches 65 are intended to cooperate, for example, with an indexing finger 66 pushed by a spring 66b (visible in FIG. 4) compressed by a plug 67, adjustable or not, as illustrated for example in FIGS. 3 and 4.

In one embodiment, illustrated in FIG. 4, the indexing finger 66 is provided with a ball roller 66a advantageously allowing optimizing the softness and the accuracy of indexing of the barrel 60.

In a particular embodiment of the gearbox, not illustrated in the figures, said gearbox comprises a means for blocking the barrel 60 in rotation. Advantageously, this rotation blocking means allows blocking the rotation of the barrel on the indexing notch associated with the neutral point. Thus, at the neutral point, the crankset rotates off-load. Such a blocking means forms an anti-theft device for the bicycle.

In one embodiment, this blocking means is a mechanical system, preferably actuated by a key.

In other embodiments, this blocking means is a mechatronic system, preferably actuated by a remote control or a smartphone.

All of the forks F1, F2, F3, the sliding gears C1, C2, C3, the pinions S1, S2, S3, S4, S5, S6 and the guide members of the barrel of the gearbox as described before form a gear selection system. This gear selection system actively ensures shifting of the gear ratios.

By subassembly of the gear selection system, or simply subassembly, it should be understood a fork, the sliding gear, the two idler pinions and the guide member associated together.

In the case where a sliding gear is intended to cooperate with only one single idler pinion, a subassembly is formed by a fork, the sliding gear, the idler pinion and the guide member associated together.

According to the invention, one of the elements of each subassembly comprises an elastic return means. Advantageously, such an elastic return means allows timing the operation of clutching a gear ratio and the operation of declutching from another gear ratio, during a gear shift.

In a first embodiment, in a subassembly, the fork F1, F2, F3 comprises the elastic return means.

Preferably, in all subassemblies, the fork F1, F2, F3 comprises the elastic return means.

In a fork first configuration, the blade 50 of the fork forms the elastic return means. Thus, said blade is configured to deform elastically.

For example, said blade is a flexible blade. At rest, i.e. without stress exerted thereon, the blade 50 of the fork F1, F2, F3 extends in a plane substantially perpendicular to the guide axis 55. Under stress, the blade 50 bends so that it no longer extends in a plane substantially perpendicular to the guide axis.

For example, said flexible blade may be made of a spring steel sheet metal material.

In an improved embodiment, the flexible blade of the fork F1, F2, F3 may have, on each of the faces 56 of the flexible blade, and at the free ends 521 of each branch 52, a protuberance 522, for example shaped like a hemispherical dome. Advantageously, these protuberances 522 allow reducing the contact area of the fork with walls 422 of the circular groove 421 of the associated sliding gear, on which said fork can momentarily exert a lateral pressure.

Thanks to its elasticity, the flexible blade advantageously allows timing clutching or declutching of a sliding gear with/from an idler pinion during a gear shift, as will be explained later on in an example of operation.

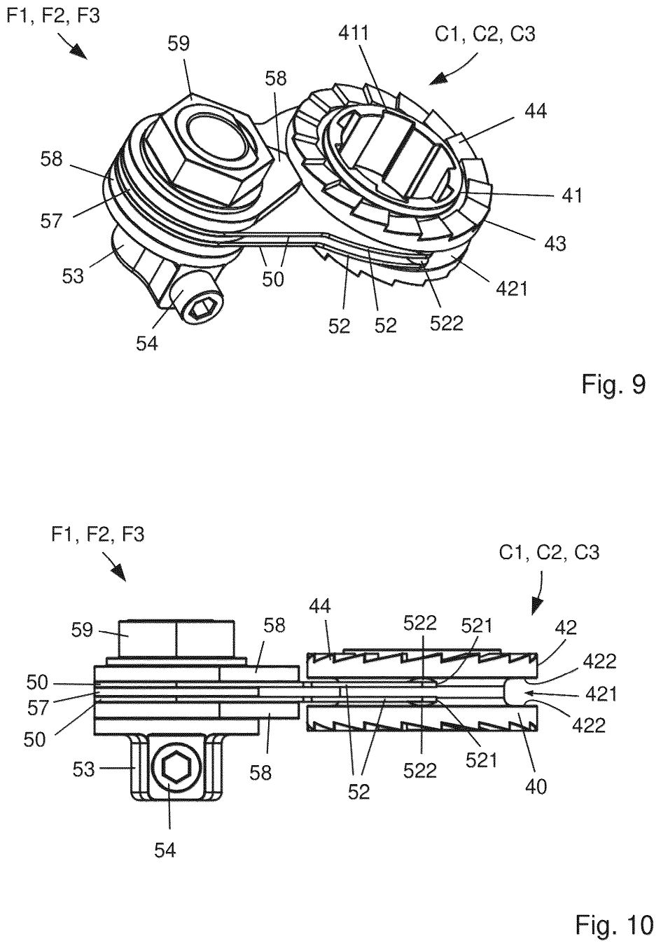

In an improved variant of the fork first configuration, as illustrated in FIGS. 9 and 10, a fork F1, F2, F3 may comprise two flexible blades 50, substantially identical and parallel, which together serve as an elastic return means.

Advantageously, such a fork F1, F2, F3 allows differentiating more easily the force of meshing of the associated sliding gear C1, C2, C3 into the idler pinion and the force of extraction of said sliding gear from the idler pinion.

Preferably, the two flexible blades 50 are spaced apart by a spacer element 57, as illustrated in FIG. 10.

In an improved embodiment, each flexible blade 50 of the fork F1, F2, F3 may have, on a face 56 facing one of the walls 422 of the circular groove 421 of the associated sliding gear, and at the free ends 521 of each branch 52, a protuberance 522, for example shaped like a hemispherical dome.

Such a fork may be mechanically assembled as follows: the core 53, a washer 58, a first flexible blade 50, the spacer element 57, a second flexible blade 50, another washer 58 then a nut 59 configured to clamp all of the parts forming the fork F1, F2, F3 together. Each of said parts comprises an orifice for the passage of the guide axis.

Preferably, the washers 58 are tab washers. Advantageously, the tab washers allow differentiating the elastic force for meshing of the associated sliding gear into the idler pinion and the elastic force for extracting said sliding gear from the idler pinion. The length and the shape of said tabs of a washer have an influence on the quality of elasticity of the fork.

In this fork first configuration, the guide member is either a track T1, T2, T3 extending over the circumferential surface of the barrel or an annular part A1, A2, A3 comprising a track T1, T2, T3 extending over the circumferential surface of the annular part A1, A2, A3, said annular part being fixedly connected to the barrel, or made in one-piece with the barrel.

In this fork first configuration, the movement of the guide finger directly drives the fork, in particular the blade 50, independently of the elastic return means.

Example of Operation of the Gearbox for this Fork First Configuration

In this embodiment, for each subassembly, the elastic return means is a flexible blade 50 of the fork. It is clear that the operation of the gearbox 1 described hereinafter can be transposed to any other elastic return means. Similarly, the elastic return means used in each subassembly may be different. In this example, the sliding gear cooperates with two idler pinions.

For example, the gearbox 1 is set in the 1^{st} gear. In other words, as described before and illustrated in FIGS. 3 to 5, the first sliding gear C1 is clutched with the first idler pinion S1, and the second and third sliding gears C2, C3 are set in the neutral position.

To perform a gear shift from the 1^{st} t gear to the 2^{nd} gear, the cyclist manipulates the selector, located at the handlebar. The selector acts on the barrel 60, via the maneuvering means. The barrel 60 then rotates until the indexing finger 66 is positioned in an indexing notch 65 of the indexing wheel 64 of the barrel 60 corresponding to the 2^{nd} gear.

All of the guide fingers 54 then move simultaneously while following the imposed movements of their respective tracks (cf. flat pattern):
the guide finger 54 of the second fork F2 follows the second track T2, moving said second fork F2 in translation on the guide axis 55, to move the second sliding gear C2 in translation towards the second idler pinion S2 until clutching,
the guide finger 54 of the first fork F1 follows the first track T1, moving said first fork F1 in translation on the guide axis, to move the first sliding gear C1 in translation and return it to the neutral,
the guide finger 54 of the third fork F3 follows the third track T3, not moving the third fork F3, or the third sliding gear C3, in translation; the third sliding gear C3 remains in the neutral position.

### a) Engagement of the 2^{nd} Gear

The second sliding gear C2 is moved in translation towards the second idler pinion S2. The second sliding gear C2, secured to the secondary shaft 20, rotates, even during movement thereof.

Throughout the description, by two secured parts or two parts linked/connected together, it should be understood two mechanically linked parts enabling at least one degree of freedom.

Yet, if, when the claws 44 of the second sliding gear C2 arrive at the complementary claws 31 of the second idler pinion S2, the claws of said second sliding gear C2 cannot cooperate with the complementary claws 31 of said second idler pinion S2, because the claws 44 of the second sliding gear C2 are not in-phase with the complementary claws 31 of the second idler pinion S2, thanks to its elasticity, the blade 50 of the second fork F2 will bend temporarily and be under stress.

As soon as the second sliding gear C2 has performed a sufficient rotation with the secondary shaft 20 in movement, enabling its claws 44 to fit in the complementary claws 31 of the second idler pinion S2, because of its elasticity, the blade 50 of the second fork F2 will automatically return to its rest state, exerting a pressing force on the second sliding gear C2 to push it laterally towards the second idler pinion S2, clutching of the second sliding gear C2 with the second idler pinion S2 and engaging the 2^{nd} gear.

Thus, the elasticity of the blade of the second fork F2 enables the second sliding gear C2, which should be coupled with the second idler pinion S2, to wait for phasing of the different claws and that being so without effort.

### b) Disengagement of the 1^{st} Gear

The guide finger 54 of the first fork F1 is moved in translation, driving said first fork in translation to move the first sliding gear C1 in translation towards its neutral position.

Yet, as long as the 1^{st} gear is engaged, the first idler pinion S1 is under pressure and it is impossible to declutch the first sliding gear C1 from said first idler pinion S1.

Thanks to its elasticity, the blade 50 of the first fork F1 will bend and be under stress.

As soon as the 2^{nd} gear is engaged, the idler pinion of the 1^{st} t gear will start rotating less quickly than the secondary shaft 20 which carries it and the pressure on the first sliding gear S1 will then be released. The claws 44 of said first sliding gear C1 and the claws 31 of the first idler pinion S1 are then naturally uncoupled.

Thanks to its elasticity, the blade 50 of the first fork F1 will then automatically return to its rest state, exerting a return force on the first sliding gear C1 to bring it back into its neutral position after declutching from the first idler pinion S1.

Thus, the elasticity of the blade 50 of the first fork F1 enables the first sliding gear C1, which should be uncoupled from the first idler pinion S1, to return to its neutral position, to wait for the pressure on said first idler pinion S1 to be released, smoothly, without effort and naturally.

Advantageously, thanks to the elasticity of the blade 50 of the forks F1, F2, F3, such a gearbox 1 according to the invention allows simultaneously programming the engagement of a gear and the disengagement of the other gear.

Advantageously, thanks to the elasticity of the blade 50 of the forks, the gearbox 1 according to the invention enables the simultaneous engagement of two successive gears for a very short time, in the range of one millisecond to one second for example.

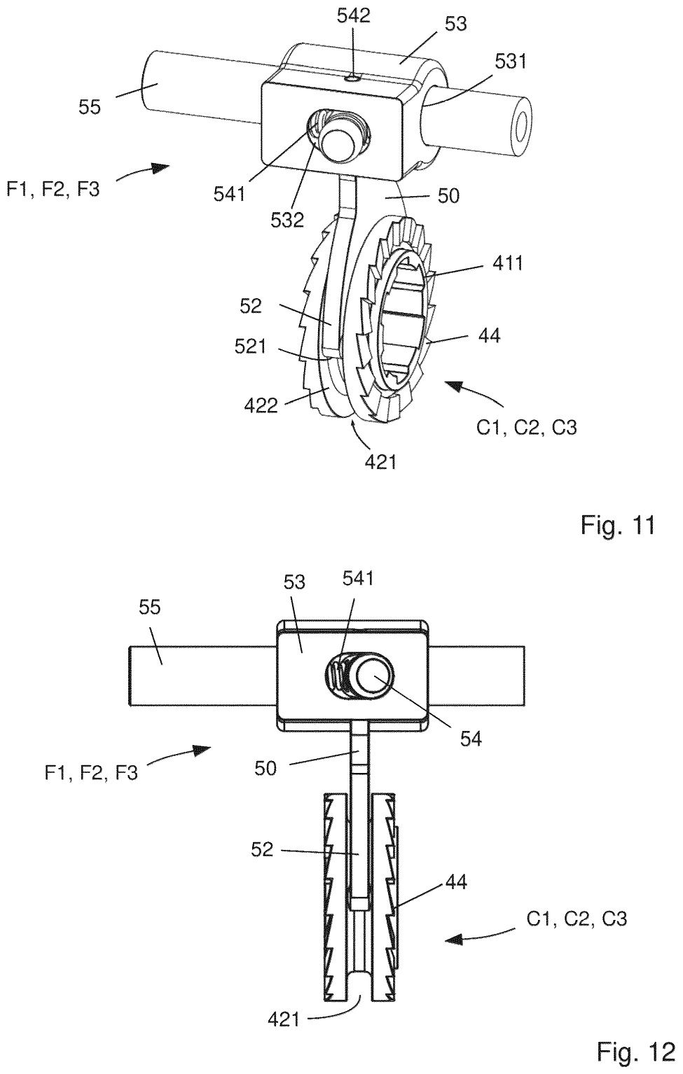

In a fork second configuration, as illustrated in FIGS. 11 to 14, the guide finger 54 associated with springs 541 form the elastic return means.

The guide finger 54 oscillates about an axis, called pivot axis 542, an axis perpendicular to the guide axis 55. Preferably, the guide axis extends in a plane substantially formed by the blade 50 of the fork, when the associated sliding gear is in the neutral position.

Preferably, the guide finger 54, so-called the oscillating guide finger, partially fits in the core 53 of the fork. Thus, the core 53 advantageously serves as a support for said pivot axis.

The core 53 further comprises an aperture 532 for the passage of the guide finger 54. Said aperture has a dimension larger than the dimension, in cross-section, of the guide finger 54 to enable movement of said guide finger in said aperture.

The springs 541 are arranged on either side of the guide finger 54, in the core 53. At rest, or in the minimum stress state, the springs 541 hold the guide finger 54 centered in the aperture 532 of the core.

The guide finger 54 cooperates with the fork F1, F2, F3, pivoting of the guide finger causing the lateral movement of the fork.

In this fork second configuration, the blade 50 of said fork is a rigid blade. The blade 50 may be made in one-piece with the core 53 or be fixedly connected to the core 53.

In this fork second configuration, the guide member is either a track T1, T2, T3 extending over the circumferential surface of the barrel or an annular part A1, A2, A3 comprising a track T1, T2, T3 extending over the circumferential surface of the annular part A1, A2, A3, said annular part being fixedly linked to, or made in one-piece with, the barrel.

Example of Operation of the Gearbox for this Fork Second Configuration

In this example, the elastic return means is the same for each subassembly. Similarly, the elastic return means used in each subassembly may be different.

In this example, for each subassembly, the sliding gear cooperates with two idler pinions. The sliding gear and the two idler pinions do not comprise any elastic return means.

For example, the gearbox 1 is set in the 2^{nd} gear. In other words, as described before and illustrated in FIGS. 3 to 5, the second sliding gear C2 is clutched with the first idler pinion S2, and the first and third sliding gears C1, C3 are in the neutral position.

To perform a gear shift from the 2^{nd} gear to the 3^{rd} gear, the cyclist manipulates the selector, located at the handlebar. The selector acts on the barrel 60, via the maneuvering means. The barrel 60 then rotates until the indexing finger 66 is positioned in an indexing notch 65 of the indexing wheel 64 of the barrel corresponding to the 3^{rd} gear.

All of the guide fingers 54 then move simultaneously while following the imposed movements of their respective tracks (cf. flat pattern):
the guide finger 54 of the first fork F1 follows the first track T1, moving the first fork F1, and its core 53, in translation on its guide axis 55, to move the first sliding gear C1 in translation towards the third idler pinion S3 until clutching,
the guide finger 54 of the second fork F2 follows the second track T2, moving the second fork F2, and its core 53, in translation on the guide axis 55, to move the second sliding gear C2 in translation and return it to the neutral,
the guide finger 54 of the third fork F3 follows the third track T3, not moving the third fork F3, or the third sliding gear C3, in translation; the third sliding gear C3 remains in the neutral position.

### a) Engagement of the 3^{rd} Gear

The first sliding gear C1 is moved in translation towards the third idler pinion S3. The first sliding gear C1, secured to the secondary shaft 20, rotates, even during movement thereof.

Yet, if, when the claws 44 of the first sliding gear C1 arrive at the complementary claws 31 of the third idler pinion S3, the claws 44 of said first sliding gear C1 cannot cooperate with the complementary claws 31 of said first idler pinion S1, because the claws of the first sliding gear C1 are not in-phase with the complementary claws of the first idler pinion S1, the translation of the first sliding gear C1 is blocked, simultaneously blocking the translation of the first fork F1 and of its core 53 on the guide axis 55. The guide finger 54 of the first fork F1 continues to follow the first track T1, while shifting into the aperture 532 of the core 53 and compressing one of the springs 541 in said core, which is then temporarily under stress.

As soon as the first sliding gear C1 has performed a sufficient rotation with the secondary shaft 20 in movement, enabling its claws 44 to fit in the complementary claws 31 of the third idler pinion S3, because of its elasticity, the compressed spring will automatically return to its rest state, causing movement of the core 53 from the first fork F1 along the guide axis 55, and therefore movement of the blade 50 of the first fork F1 and of the associated first sliding gear C1. Thus, the first sliding gear C1 is pushed laterally towards the third idler pinion S3, clutching the first sliding gear C1 with the third idler pinion S3 and engaging the 3^{rd} gear.

### b) Disengagement of the 2^{nd} Gear

The guide finger 54 of the second fork F2 is moved in translation, driving said fork in translation to move the second sliding gear C2 in translation towards its neutral position.

Yet, as long as the 2^{nd} gear is engaged, the second idler pinion S2 is under pressure and it is impossible to declutch the second sliding gear C2 from the second idler pinion S2.

The translation of the second sliding gear C2 is temporarily blocked, simultaneously blocking the translation of the second fork F2 and of its core 53 on the guide axis 55. The guide finger 54 of the second fork F2, which continues to follow the second track T2, while shifting into the aperture 532 of the core 53, and compressing one of the springs 541 in said core, which is then temporarily under stress.

As soon as the 3^{rd} gear is engaged, the idler pinion of the 2^{nd} gear will start rotating less quickly than the secondary shaft 20 which carries it and the pressure on the second sliding gear S2 will then be released. The claws of the second sliding gear C2 and those of the second idler pinion S2 are then naturally uncoupled.

Because of its elasticity, the compressed spring will automatically return to its rest state, causing movement of the core 53 of the second fork F2 along the guide axis 55, and therefore movement of the blade 50 of the second fork F2 and of the associated second sliding gear C2. Thus, the second sliding gear C2 is spaced apart laterally from the second idler pinion S2 and brought back into its neutral position after declutching from the second idler pinion S2.

Thus, the elasticity of the spring in the core of the second fork F2 enables the second sliding gear C2, which should be uncoupled from the second idler pinion S2, to return to its neutral position, to wait for the pressure on said second idler pinion S1 to be released, smoothly, without effort and naturally.

In a second embodiment, in a subassembly, each idler pinion S1, S2, S3, S4, S5, S6 comprises the elastic return means.

Preferably, in all subassemblies, each idler pinion comprises the elastic return means.

An idler pinion comprises, as illustrated in FIGS. 15 and 16:
an outer portion 35, in the form of an annular element, comprising an inner periphery 351, an outer periphery 352, and a so-called bearing lateral face 353,
a central portion 34 intended to be inserted into the outer portion 35,
a spring 36 intended to fit between the central portion 34 and the bearing face 353.

On the outer periphery 352 of the outer portion 35, the straight toothing of the idler pinion is found, for the gear with the straight toothing of the associated wheel.

The inner periphery 351 of the outer portion 35 comprises longitudinal grooves 354.

The central portion 34 comprises, at an outer periphery 342, longitudinal grooves 344 complementary to the longitudinal grooves 354 of the inner periphery 351 of the outer portion 35, to advantageously ensure the rotational connection of said central portion with the outer portion, while enabling a translational movement of said central portion in/out of the outer portion, according to the second axis of rotation 21.

The central portion 34 comprises, at an inner periphery 341, a plain bearing receiving the secondary shaft 20 and enabling said idler pinion to rotate freely on said secondary shaft.

The central portion 34 comprises the claws 31 at the level of a lateral face.

The spring 36 forms the elastic return means.

Preferably, the spring 36 is a spring working in tension or in compression, depending on the loads. The spring 36 may be fixedly linked at one end to the outer portion 35, preferably to the bearing lateral face 353, and at an opposite end, to the central portion 34.

When the spring 36 is at rest, the central portion 34 is inserted into the outer portion 35 so that only the claws 31 emerge. FIG. 15 is a perspective view of the assembled idler pinion, in its rest situation or when it is clutched before a sliding gear.

When the spring 36 is compressed, the central portion 34 is inserted into the outer portion 35 such that the claws no longer emerge.

Retaining members (not shown) are configured to prevent the lateral movement of the central portion 34 out of the outer portion 35. For example, such retaining elements are positioned between the outer portion 34 and the central portion 34 or between the central portion 34 and the secondary shaft 11.

In a variant (not illustrated by a figure) of the second embodiment, in a subassembly, each sliding gear C1, C2, C3 comprises the elastic return means instead of the idler pinion.

By analogy with an idler pinion, the sliding gear comprises an outer portion, a central portion intended to be inserted into the outer portion and a spring intended to be inserted between the central portion and a bearing face of the outer portion.

In this second embodiment and its variant, the blade 50 of said fork is a rigid blade. The blade 50 may be made in one-piece with the core 53 or be fixedly connected to the core 53. The guide finger 54 is not an oscillating guide finger.

In this second embodiment and its variant, the guide member is either a track T1, T2, T3 extending over the circumferential surface of the barrel or an annular part A1, A2, A3 comprising a track T1, T2, T3 extending over the circumferential surface of the annular part A1, A2, A3, said annular part being fixedly connected to, or made in one-piece with, the barrel 60.

In this second embodiment and its variant, the movement of the guide finger directly drives the fork, in particular the blade 50, independently of the elastic return means.

Example of Operation of the Gearbox for the Second Embodiment (Case where the Idler Pinions Comprise the Elastic Return Means)

In this example, the elastic return means is the same for each subassembly.

However, the elastic return means used in each subassembly may be different.

In this example, for each subassembly, the sliding gear cooperates with two idler pinions. The sliding gear and the two idler pinions do not comprise any elastic return means.

This example of operation can be transposed to the case where it is the sliding gear which comprises the elastic return means.

For example, the gearbox 1 is set in the 3^{rd} gear.

To perform a gear shift from the 3^{rd} to the 4^{th} gear, the cyclist manipulates the selector, located at the handlebar. The selector acts on the barrel 60, via the maneuvering means. The barrel 60 then rotates until the indexing finger 66 is positioned in an indexing notch 65 of the indexing wheel 64 of the barrel corresponding to the 4^{th} gear.

All of the guide fingers 54 then move simultaneously while following the imposed movements of their respective tracks (cf. flat pattern):
the guide finger 54 of the third fork F3 follows the third track T3, moving the third fork F3 in translation on its guide axis 55, to move the third sliding gear C3 in translation towards the fourth idler pinion S4 until clutching,
the guide finger 54 of the first fork F1 follows the first track T1, moving the first fork F1 in translation on the guide axis 55, to move the first sliding gear C1 in translation and return it to the neutral,
the guide finger 54 of the second fork F2 follows the second track T2, not moving the second fork F2 or the second sliding gear C2 in translation;
the second sliding gear C2 remains in the neutral position.

### a) Engagement of the 4^{th} Gear

The third sliding gear C3 is moved in translation towards the fourth idler pinion S4. The third sliding gear C3, secured to the secondary shaft 20, rotates, even during movement thereof.

Yet, if, when the claws 44 of the third sliding gear C3 arrive at the level of the complementary claws 31 of the fourth idler pinion S4, the claws 44 of said third sliding gear C3 cannot cooperate with the complementary claws 31 of said fourth idler pinion S4, because the claws 44 of the third sliding gear C3 are not in-phase with the complementary claws 31 of the fourth idler pinion S4, the central portion 34 of the fourth idler pinion S4 is pushed laterally by the third sliding gear C3 towards the inside of the outer portion 35 of the fourth idler pinion S4, in the direction of the arrow Sx as illustrated in FIG. 16, compressing the spring 36. Said spring is then under stress.

As soon as the third sliding gear C3 has performed a sufficient rotation with the secondary shaft 20 in movement, enabling its claws 44 to be in-phase and could be accommodated in the claws 31 complementary to the idler pinion S4, the spring 36 will return to its rest state, exerting a force on the central portion 34 to push it laterally towards the third sliding gear C3, causing clutching of said third sliding gear C3 with said fourth idler pinion S4 and engagement of the 4^{th} gear.

### b) Disengagement of the 3^{rd} Gear

The guide finger 54 of the first fork F1 is moved in translation, driving said first fork F1 in translation to move the first sliding gear C1 in translation towards its neutral position.

Yet, as long as the 3^{rd} gear is engaged, the third idler pinion S3 is under pressure and it is impossible to declutch the first sliding gear C1 from the third idler pinion S3.

The central portion 54 of the third idler pinion S3 is driven laterally with the first sliding gear C1, resulting in a slight stretching of the spring 36.

As soon as the 4^{th} gear is engaged, the idler pinion of the 3^{rd} gear will start rotating less quickly than the secondary shaft 20 carrying it and the pressure on the first sliding gear C1 will then be released. The claws 44 of the first sliding gear C1 and those of the third idler pinion S3 are then naturally uncoupled.

The spring 36 will then automatically return to its rest state, exerting a return force on the central portion 34 of the third idler pinion S3 to separate it from the first sliding gear C1 and bring it back into the outer portion 35 of said third idler pinion S3.

The first sliding gear becomes again free in rotation relative to the secondary shaft.

In a third embodiment, in a subassembly, the guide member comprises the elastic return means.

Preferably, in all subassemblies, each guide member comprises the elastic return means.

In this third embodiment (not shown in the figures), the guide member comprises an annular part A1, A2, A3 affixed on the barrel 60. The annular part A1, A2, A3 comprise a track T1, T2, T3 extending over the circumferential surface of said annular part. Said annular part is only linked in rotation to the barrel 60 and free in translation over a predefined distance. The guide member comprises a spring (not shown in the figures) arranged against the annular part A1, A2, A3, at the level of a lateral face. For example, said spring is connected, at one end, to the annular part and, at another end, to a stop, fixedly connected to the barrel.

The spring forms the elastic return means.

At rest, or in the minimum stress state, the spring holds the annular part in a position such that the straight sections of the track are arranged so that the sliding gear is either in the neutral position, or clutched with one of the idler pinions.

In this third embodiment and its variant, the blade 50 of said fork is a rigid blade. The blade 50 may be made in one-piece with the core 53 or be fixedly linked to the core 53. The guide finger 54 is not an oscillating guide finger.

Preferably, the guide member comprises at least two springs. Each spring is arranged on either side of the annular part, at the level of opposite lateral faces of said annular part. Each spring is connected, at one end, to said annular part and, at another end, to a fixed stop on the barrel 60. Said at least two springs form the elastic return means.

In this third embodiment, the movement of the guide finger directly drives the fork, in particular the blade 50, independently of the elastic return means.

Example of Operation of the Gearbox for this Third Embodiment

In this example, the elastic return means is the same for each subassembly. Similarly, the elastic return means used in each subassembly may be different.

In this example, in each subassembly, the sliding gear cooperates with two idler pinions. The sliding gear and the two idler pinions do not comprise any elastic return means.

For example, the gearbox 1 is set in the 2^{nd} gear. In other words, as described before and illustrated in FIGS. 3 to 5, the second sliding gear C2 is clutched with the first idler pinion S2, and the first and third sliding gears C1, C3 are in the neutral position.

To perform a gear shift from the 2^{nd} gear to the 3^{rd} gear, the cyclist manipulates the selector, located at the handlebar. The selector acts on the barrel 60, via the maneuvering means. The barrel 60 then rotates until the indexing finger 66 is positioned in an indexing notch 65 of the indexing wheel 64 of the barrel corresponding to the 3^{rd} gear.

All of the guide fingers 54 then move simultaneously while following the imposed movements of their respective tracks (cf. flat pattern):
the guide finger 54 of the first fork F1 follows the first track T1, moving the first fork F1, and its core 53, in translation on its guide axis 55, to move the first sliding gear C1 in translation towards the third idler pinion S3 until clutching,
the guide finger 54 of the second fork F2 follows the second track T2, moving the second fork F2, and its core 53, in translation on the guide axis 55, to move the second sliding gear C2 in translation and return it to the neutral,
the guide finger 54 of the third fork F3 follows the third track T3, not moving the third fork F3, or the third sliding gear C3, in translation; the third sliding gear C3 remains in the neutral position.

### a) Engagement of the 3^{rd} Gear

The first sliding gear C1 is moved in translation towards the third idler pinion S3. the first sliding gear C1, secured to the secondary shaft 20, rotates, even during movement thereof.

Yet, if, when the claws 44 of the first sliding gear C1 arrive at the complementary claws 31 of the third idler pinion S3, the claws 44 of said first sliding gear C1 cannot cooperate with the complementary claws 31 of said first idler pinion S1, because the claws of the first sliding gear C1 are not in-phase with the complementary claws of the first idler pinion S1, the translation of the first sliding gear C1 is blocked, simultaneously blocking the translation of the first fork F1 and of its core 53 on the guide axis 55. The guide finger 54 of the first fork F1, continuing to follow the first track T1, causes a lateral offset of the annular part A1, either compressing or stretching the spring, depending on the positioning of the spring with respect to the annular part. Said spring is then under stress.

As soon as the first sliding gear C1 has performed a sufficient rotation with the secondary shaft 20 in movement, enabling its claws 44 to fit in the complementary claws 31 of the third idler pinion S3, because of its elasticity, the compressed or stretched spring will automatically return to its rest state, causing movement of the annular part A1 on the barrel, along the barrel axis, and consequently causing movement of the core 53 of the first fork F1 along the guide axis 55, and therefore movement of the blade 50 of the first fork F1 and of the associated first sliding gear C1. Thus, the first sliding gear C1 is pushed laterally towards the third idler pinion S3, clutching the first sliding gear C1 with the third idler pinion S3 and engaging the 3^{rd} gear.

### b) Disengagement of the 2^{nd} Gear

The guide finger 54 of the second fork F2 is moved in translation, driving said fork in translation to move the second sliding gear C2 in translation towards its neutral position.

Yet, as long as the 2^{nd} gear is engaged, the second idler pinion S2 is under pressure and it is impossible to declutch the second sliding gear C2 from the second idler pinion S2.

The translation of the second sliding gear C2 is temporarily blocked, simultaneously blocking the translation of the second fork F2 and its core 53 on the guide axis 55. The guide finger 54 of the second fork F2, continuing following the second track T2, causes an offset of the annular part A2, either stretching or compressing the spring. Said spring is then temporarily under stress.

As soon as the 3^{rd} gear is engaged, the idler pinion of the 2^{nd} gear will start rotating less quickly than the secondary shaft 20 which carries it and the pressure on the second sliding gear S2 will then be released. The claws of the second sliding gear C2 and those of the second idler pinion S2 are then naturally uncoupled.

Because of its elasticity, the spring will automatically return to its rest state, causing movement of the annular part A2 on the barrel 60, according to the barrel axis, and consequently driving the core 53 of the second fork F2 along the guide axis 55, and therefore movement of the blade 50 of the second fork F2 and of the associated second sliding gear C2. Thus, the second sliding gear C2 is spaced laterally apart from the second idler pinion S2 and brought back into its neutral position after declutching from the second idler pinion S2.

Thus, the elasticity of the spring in the core of the second fork F2 enables the second sliding gear C2 which should be uncoupled from the second idler pinion S2 to return towards its neutral position, to wait for the pressure on said second idler pinion S1 to be released, smoothly, without effort and naturally.

### Second Version of the Gearbox

FIGS. 17 to 27 show the gearbox 1 suited for use on a vehicle provided with a heat engine where the engine brake is used. In the described example, this vehicle is a kart.

FIG. 17 shows a perspective view of said gearbox.

Like for the first version of the gearbox, the latter comprises the same elements:
the primary shaft 10, driven in rotation about its first axis of rotation 11,
the secondary shaft 20, driven in rotation about its second axis of rotation 21,
the gears E1, E2, E3, E4, E5, E6, comprising the gear wheels P1, P2, P3, P4, P5, P6 fixedly linked, in rotation and in translation, to the primary shaft 10 and the idler pinions S1, S2, S3, S4, S5, S6 fixedly linked, in translation, to the secondary shaft 20; in the example, the gears are also 6 in number,
the sliding gears C1, C2, C3, secured in rotation about the secondary shaft 20 but movable in translation; in the example the sliding gears are 3 in number,
the forks F1, F2, F3, one fork per sliding gear, movable in translation on the guide axis 55; in the example, the forks are 3 in number; each fork comprising a guide finger 54,
the barrel 60 comprising the guide members with its tracks T1, T2, T3 and its indexing wheel 64; each guide member is either a track extending over the circumferential surface of the barrel or an annular part A1, A2, A3 comprising a track T1, T2, T3 extending over the circumferential surface of the annular part, said annular part being fixedly linked to, or made in one-piece with, the barrel; each of the guide fingers 54 of the forks F1, F2, F3 is respectively inserted into one of the tracks T1, T2, T3.

The positioning of the aforementioned different elements is substantially identical to that of the first version of the gearbox.

In this second version, the primary shaft 10 is intended and configured to be connected to a clutch system (not shown).

In a preferred embodiment of the arrangement of the gears, and as illustrated in FIGS. 17, 21 to 23, for the second version of the gearbox, the idler pinions are this time successively mounted on the secondary shaft in the following order: S1, S4, S5, S3, S6, S2. Similarly, the wheels are successively fastened on the primary shaft in the following order: P1, P4, P5, P3, P6, P2. Hence, the gear ratios are in the following order: 1^{st}, 4^{th}, 5^{th}, 3^{rd}, 6^{th}, 2^{nd}. The non-continuous arrangement of the numbers of the gears, although different from that of the first version of the gearbox, still allows temporarily engaging two successive gears at the same time, in order not to have a break in the torque in the transmission of the engine movement.

Thus, the sliding gears C1, C2, C3 are now respectively positioned between the first and fourth idler pinions S1, S4, the fifth and third idler pinions S5, S3 and the sixth and second idler gears C1, C2, C3 respectively allow engaging the 1^{st} and 4^{th} gear ratios, the 5^{th} and 3^{rd} gear ratios, and the 6^{th} and 2^{nd} gear ratios.

FIGS. 18 to 23 show the protective casings 80 of a kart engine block inside which the gearbox 1 according to the second version is installed.

In these figures, an end portion of the primary shaft 10, an end portion of the secondary shaft 20, the plug 67 (FIG. 18) associated with the indexing wheel 64 of the barrel 60 are visible. Also shown in these figures are a clutch lever 81 and its axis, called declutch axis 82, intended to control a clutch rod (not shown) which passes through the primary shaft 10. The declutch axis 82 of the clutch lever 81 comprises, in a conventional manner, at its lower end, a cam which pushes the clutch rod, advantageously allowing spacing clutch discs (not shown) apart.

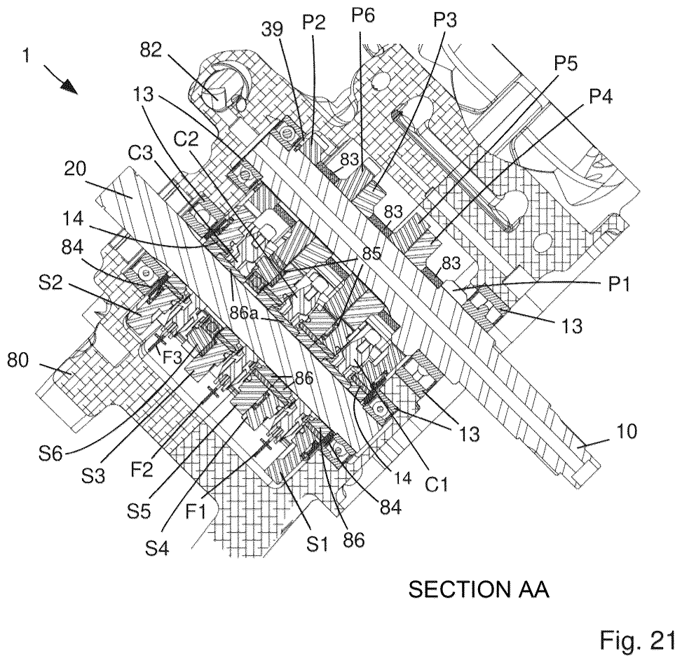

FIGS. 21 to 23 respectively show a cross-sectional view of the gearbox, surrounded by its protective casings 80, of FIG. 20 according to the line AA, BB and CC.

In FIG. 17, and also visible in FIG. 21, spacer pieces 83 are arranged between the wheels of the gears. These spacer part 83, three in number, are arranged respectively between the first and fourth wheels P1, P4, the fifth and third wheels P5, P3, and the sixth and second wheels P6, P2. Advantageously, these spacer pieces 83 allow spacing the wheels apart, so that they could face the associated idler pinions, which idler pinions are spaced apart for movement of the sliding gears C1, C2, C3.

In FIG. 21, one could imagine the ball bearings 13 of the primary 10 and secondary 20 shafts to guide them respectively in rotation about their first and second axes of rotation 11, 21. Preferably, these ball bearings 13 are accommodated in abutment in the protective casings. Shouldered shim washers 84 are also visible at the two ends of the secondary shaft 20. The shim washers 84 may be concentric with a stud (not shown).

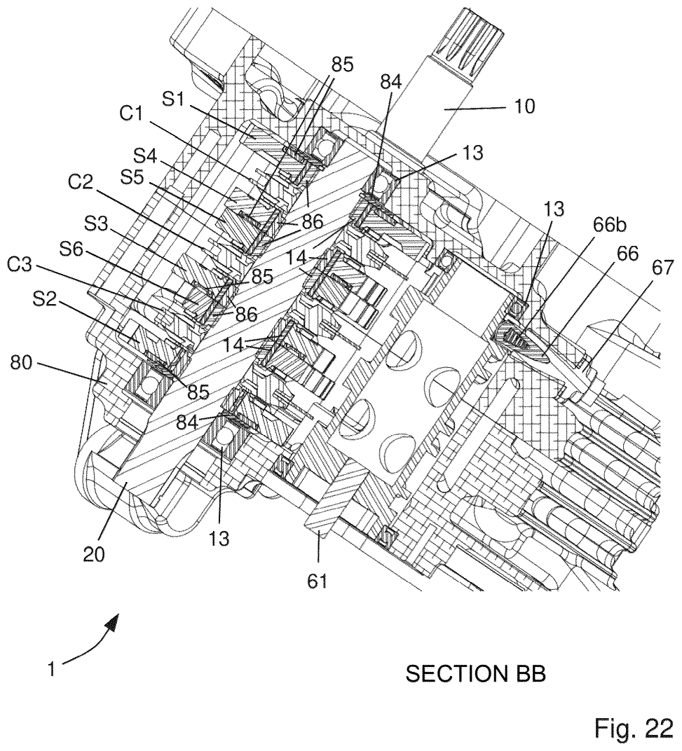

In an embodiment of an idler pinion, and as illustrated in FIG. 21 by the pinions S1, S2, S3, S4 and S5 or in FIG. 22 for the pinion S6, the idler pinion is an annular element 30 comprising, on a lateral face, a needle stop 85 and at its inner periphery, a needle bearing 14 which rotates on a shouldered bearing 86 to laterally retain the idler pinion on the sliding gear side. Preferably, said bearing is externally smooth and internally splined. Said bearing further comprises compartments, for example three compartments distributed every 120°, intended to receive the ends of cylindrical needles 86a. For example, these cylindrical needles 86a are embedded in some longitudinal splines of the secondary shaft 20. Advantageously, the cylindrical needles 86a allow controlling the accurate spacing between two idler pinions sharing the same sliding gear which therefore slides on these cylindrical needles 86a. these cylindrical needles form spacer elements for maintaining the spacing between said two idler pinions. Advantageously, said cylindrical needles replace the conventionally used clip grooves, causing breakage primers, which are risk factors of breakage of the shaft carrying the idler pinions, herein the secondary shaft.

The dimension chain of the stack, on the secondary shaft 20, of the shim washers 84, bearings 86, and cylindrical needles 86a allows for a minimum, and even zero, clearance with the ball bearings 13 located at the ends of said secondary shaft.

In a simplified embodiment of an idler pinion, and as illustrated in FIG. 21 by the sixth pinion S6 or in FIG. 25, the needle stop 85 and the needle bearing 14 are replaced by a simple ball bearing 13.

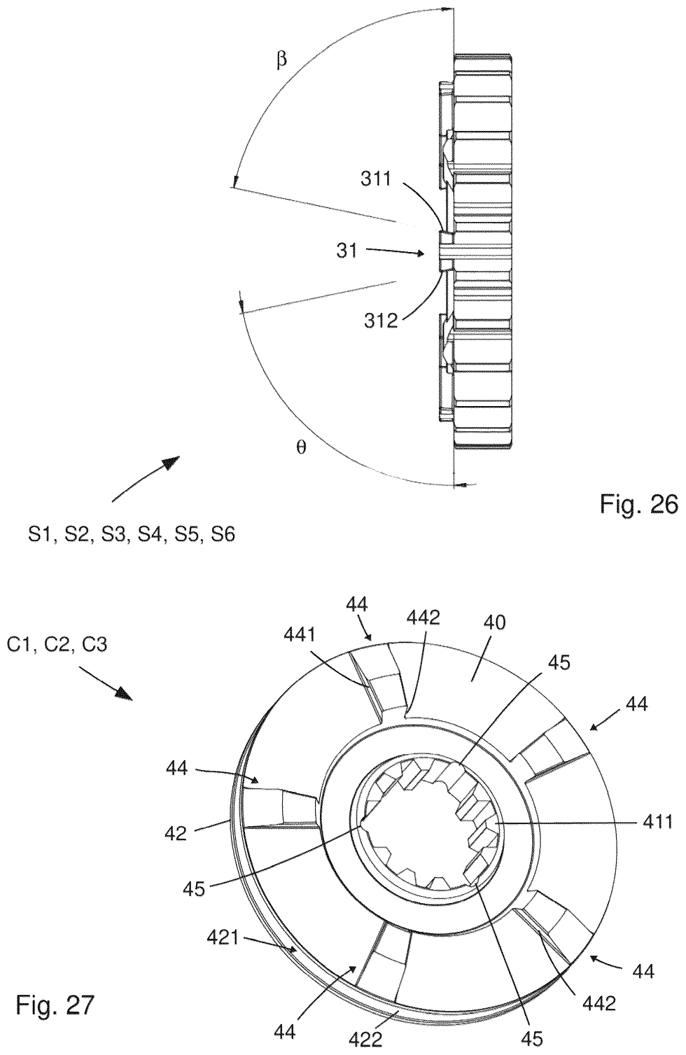

In one embodiment of an idler pinion, as illustrated in FIG. 26, the claws 31 are tenon-type lugs. Preferably, the tenons have a trapezoidal section, with the small base of the tenons located on the side of the lateral face 32 of the idler pinion.

The claws 31 of the idler pinion comprise:
a first side 311 forming an acute angle α, with respect to the lateral face 32 of the idler pinion, to guarantee the perfect hold of the drive connection with the sliding gear with which it cooperates to define a gear ratio; preferably, this angle α is in the range of 85°±5°
a second side 312 forming an angle θ, with respect to the lateral face 32 of the idler pinion, preferably comprised between 85° and 165°, more preferably in the range of 90°, defined to optimize the acceptable engine brake force.

Advantageously, the large base of the claw 31 of the idler pinion allows guaranteeing the ejection of the sliding gear cooperating with said idler pinion, during a gear shift, for the ejected gear ratio.

In a preferred embodiment, as illustrated in FIG. 25, protruding elements 38 are arranged concentrically, between the claws 31 of the idler pinion. Such protruding elements 38 may have a substantially identical height or smaller than the height of the claws 31 of the idler pinion. These protruding elements 38 have a V-roof like general shape, symmetrical or not, having two adjacent sides forming therebetween an angle larger than 90°. Advantageously, the adjacent sides allow assisting the blade 50 of the fork in ejecting the sliding gear during a gear shift.

In one variant, these protruding elements may be positioned on the sliding gear C1, C2, C3 instead of the idler pinion.

In one embodiment of a sliding gear, as illustrated in FIG. 27, the claws 44 of said sliding gear C1, C2, C3 have first 441 and second 442 sides having a shape respectively complementary to the first 311 and second 312 sides of the claws 31 of the idler pinion with which it cooperates. In this FIG. 27, one could also notice that some projecting portions of the longitudinal splines 411 have disappeared and are replaced by three hollow longitudinal housings 45, intended to enable the passage of the cylindrical needles 86a. Preferably, these housings 45, three in number in FIG. 27, are made by material removal.

As illustrated in FIG. 22, the barrel 60 is guided in rotation about its barrel axis 61 by ball bearings 13, in the example located at the two ends of the barrel.

In this second version of the gearbox, the barrel axis 61 is configured to receive a mechanism adapted to cooperate with a manual or kick lever of the gear selector of the kart.

Advantageously, besides the 6 gear ratios, the gearbox 1 comprises a neutral point. This neutral point is characterized by a positioning of all of the sliding gears C1, C2, C3 at the neutral.

Besides the indexing notches 65 for each gear of the gearbox, the indexing wheel 64 of the barrel comprises over the circumference of said barrel an additional indexing notch for positioning at the neutral point. Preferably, this additional indexing notch is formed between the indexing notch for the 1^{st} gear and the indexing notch for the 6^{th} gear. Thus, the gear program is established as follows: 0, 1^{st}, 2^{nd}, 3^{rd}, 4^{th}, 5^{th}, 6^{th}.

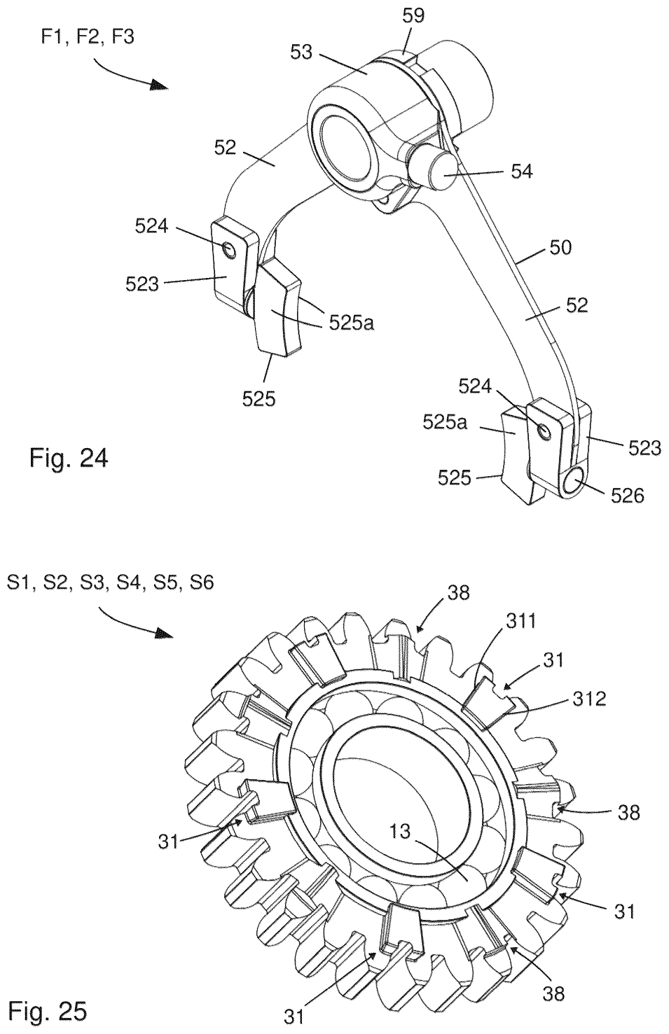

Like for the first version of the gearbox, all of the indexing notches 65 cooperate, preferably, with an indexing finger 66 pushed by a spring compressed by a plug, as illustrated for example in FIG. 24.

In a particular embodiment of the gearbox, as illustrated in FIG. 17, said gearbox comprises an anti-neutral blocking system 70.

The anti-neutral blocking system 70 comprises a blocking rod 71, as illustrated in FIG. 17. Preferably, the blocking rod is pushed by a spring 72 against a cam (some kind of a swirler) formed in the declutch axis 82. Advantageously, this additional cam facing the conventional cam that actuates the clutch rod, allows raising said blocking rod 71 under the action of said spring. Thus, when the pilot actuates his/her clutch lever (or his/her pedal), the blocking rod 71 is sufficiently raised so that a boss 89, formed on the barrel 60, could pass under said blocking rod in order to enable the rotation of the barrel 60 to search for the neutral position. Once the boss 89 is crossed, the neutral point is selected by releasing the clutch, the blocking rod 71 descends behind the boss 89 which consequently prevents switching into the 1^{st} gear (or any other speed) by error.

The fact that the gearbox could allow raising or lowering as much gears as desired, with the engine running or at stop, without the need to make the different claw areas coincide, is secured by means of this anti-neutral blocking system 70, which prevents the dead center from inadvertently returning to neutral gear or switching from the neutral gear to an upper gear.

In a variant (not shown) of the anti-neutral blocking system, the clutch lever 81 actuates a cable connected to the indexing finger 66. When the pilot declutches, said cable pulls on the indexing finger, which makes it come out from a deeper area in the notch of the 1^{st} gear and which blocks rotation thereof only towards the neutral point, then when the neutral point is selected, fall into an indexing notch similar to that of the 1^{st} gear to block the neutral point, unless the pilot declutches.

In the previous two embodiments, the anti-neutral blocking system 70 is a mechanical system. Without departing from the scope of the invention, it is possible to make an anti-neutral blocking system which is fully mechanical, hydraulic, pneumatic, electromagnetic, etc., or not, and which can be actuated synchronously and therefore simultaneously with the clutch system (stick, pedal, lever, etc.), or completely independent of said clutch system.

For this second version of the gearbox, the gear selection system is always formed by all of the forks, sliding gears, idler pinions and members for guiding the barrel of the gearbox, as for the first version. Similarly, a subassembly is formed by a fork, the sliding gear, the two idler pinions and the associated guide member.

In the case where a sliding gear is intended to cooperate only with one single idler pinion, a subassembly is formed by a fork, the sliding gear, the idler pinion and the associated guide member.

Preferably, in this second version of the gearbox, the blade 50 of the fork of a subassembly forms the elastic return means. Thus, the blade is configured to deform elastically.

Like for the first version of the gearbox, said blade consists for example of a flexible blade. At rest, i.e. with no stress exerted thereon, the blade 50 of the fork F1, F2, F3 extends in a plane substantially perpendicular to the guide axis 55. Under stress, the blade 50 bends so that it no longer extends in a plane substantially perpendicular to the guide axis 55.

For example, said flexible blade may be made of a spring steel sheet metal material. It may also be made of a composite material, such as for example carbon, or any other material having a relatively high elastic limit. In one embodiment, the flexible blade is made of a material having a bending within the elastic limit corresponding substantially to a height of the claws plus at least one millimeter.

Preferably, as illustrated in FIG. 24, each of the free ends 521 of the branches 52 of the blade 50 of a fork comprises a clevis 523. Each clevis 523 may be fastened at the free end 521 of a branch 52 by a screwing element 524, such as for example a screw or a rivet. Each clevis 523 comprises a bore 526 for receiving a friction pad 525. Said friction pad can rotate freely about a longitudinal axis of the bore 526 of the clevis. The friction pad 525 is intended to cooperate with the circular groove 421 of the associated sliding gear C1, C2, C3.

In one embodiment, the friction pad 525 may have, in section in a substantially radial plane with respect to the associated sliding gear, a bowl-like shape the sidewalls 525a of which come into frictional contact with the corresponding walls 422 of the circular groove 421 of the associated sliding gear.

The core 53 of the fork F1, F2, F3 can indifferently carry, directly or affixed thereto, the guide finger 54 intended to cooperate with one of the tracks T1, T2, T3 of the barrel 60. Tightening of the flexible blade 50 on the core 53 may be done by a nut.

Such an embodiment of the fork F1, F2, F3 is perfectly suited for gearboxes 1 used on vehicles provided with a heat engine, the primary 10 and secondary 20 shafts of which rotate at speeds that are much higher than those of a conventional bicycle and of an electrically-assisted bicycle.

Of course, the different elastic return means described for the first version of the gearbox are also applicable for this second version of the gearbox, without departing from the scope of the invention.

The operation of this second version of the gearbox is identical to that of the first version.

Advantageously, irrespective of the version that is made, the speed curve of a vehicle equipped with the gearbox according to the invention has at each gear shift greater than one positive peak (which is reflected by an increase in the speed) due to the recovery of the inertial kinetic energy of the engine, while with a conventional gearbox, this peak is negative (which results in a slight loss of speed).

Regardless of the version that is made, the gearbox could advantageously address the integration constraints in existing casings, in particular in terms of bulk, dimensions (for example, the distance between the first axis of rotation and the second axis of rotation). Thus, it is possible to consider installing such a gearbox as an original equipment on a vehicle, but also as a replacement for an existing gearbox on a vehicle, whether it is conventional or with no break in torque. Thus, such a gearbox can be sold as an accessory in replacement of a conventional gearbox, preferably on motorcycles and karts. This replacement possibility proves to be particularly interesting in sports disciplines or the casings are certified for several years.

1-13. (canceled)

14. A gearbox comprising:
forks, each fork comprising a guide finger;
a control barrel comprising guide members, each guide member being configured to guide the guide finger of a corresponding fork;
gears forming gear ratios;
a primary shaft and a secondary shaft connected together by the gears;
each gear comprising a gear wheel rotatably linked to one of the primary shaft and the secondary shaft, and an idler pinion mounted on the other of the primary shaft and secondary shaft, which mesh with one another, each idler pinion comprising first claws;
sliding gears to ensure shifting of the gear ratios, each sliding gear being configured to cooperate with one or two idler pinions;
said each sliding gear being configured to move towards associated one or two idler pinions by the fork;
said each sliding gear comprising second claws complementary to the first claws of the one or two idler pinions cooperating with said each sliding gear;
wherein all of the forks, the sliding gears, the idler pinions and the guide members of the control barrel of the gearbox forming a gear selection system;
the corresponding fork, an associated sliding gear, the one or two idler pinions cooperating with the associated sliding gear and the guide member associated with the corresponding fork forming elements of a subassembly of the gear selection system; and
wherein one element of each subassembly comprises an elastic return element, when a new gear ration is engaged, the elastic return element being configured engaged, to uncouple the associated sliding gear from the idler pinion of a gear forming a previously engaged gear ratio.

15. The gearbox of claim 14, wherein, in said each subassembly, the corresponding fork comprises the elastic return element.

16. The gearbox of claim 15, wherein the corresponding fork comprises at least one flexible blade forming the elastic return element.

17. The gearbox of claim 15, wherein the guide finger of the corresponding fork is referred to as an oscillating guide finger, the oscillating guide finger held at a neutral position by springs, the oscillating guide finger and the springs forming the elastic return element.

18. The gearbox of claim 14, wherein, in said each subassembly, the associated sliding gear or the one or two idler pinions cooperating with the associated sliding gear comprises the elastic return element.

19. The gearbox of claim 18, wherein, when the one or two idler pinions cooperating with the associated sliding gear comprises the elastic return element, each idler pinion of the one or two idler pinions comprises:
an outer portion comprising a bearing lateral face;
a central portion insertable into the outer portion, the central portion being provided with the first claws, the central portion being rotatably linked to the outer portion but free in translation; and
a spring positioned between the bearing lateral face of the outer portion and the central portion, the spring comprising a first end and a second end, the spring being fixedly held at the first end to the outer portion and held at the second end to the central portion, and the spring forming the elastic return element.

20. The gearbox of claim 14, wherein, in said each subassembly, the guide member comprises the elastic return element.

21. The gearbox of claim 20, wherein the guide member comprises:
an annular part affixed to the control barrel, rotatably linked to the control barrel but movable in translation according to a barrel axis and over a predefined distance, the annular part comprising a track extending over a circumferential surface of the track; and
at least one spring arranged against the annular part, at a level of at least one lateral face of the annular part, said at least one spring comprising a first end and a second end, said at least one spring being connected at the first end to the annular part and connected at the second end to a fixed stop on the control barrel, and said at least one spring forming the elastic return element.

22. The gearbox of claim 14, wherein the second claws of the sliding gears and the first claws of the idler pinions of the gear selection system are complementary wolf teeth-type claws.

23. The gearbox of claim 14, wherein the second claws of the sliding gears and the first claws of the idler pinions of the gear selection system are tenons.

24. The gearbox of claim 14, wherein each tenon comprises a trapezoidal section.

25. The gearbox of claim 14, wherein the one or two idler pinions of said each subassembly comprises protruding elements between the first claws.

26. The gearbox of claim 14, further comprising an anti-neutral blocking system.

27. The gearbox of claim 14, further comprising, when the associated sliding gear cooperates with two idler pinions, spacers to maintain a spacing between the two idler pinions.
